(19) United States
(12) Patent Application Publication
(10) Pub. No.: US 2024/0284374 A1
(43) Pub. Date: Aug. 22, 2024

(54) METHOD AND APPARATUS FOR V2X POSITIONING

(71) Applicant: Jaihyung Cho, San Jose, CA (US)

(72) Inventor: Jaihyung Cho, San Jose, CA (US)

(21) Appl. No.: 18/441,900

(22) Filed: Feb. 14, 2024

Related U.S. Application Data
(60) Provisional application No. 63/445,730, filed on Feb. 15, 2023.

(51) Int. Cl. H04W 56/00

(52) U.S. Cl. CPC H04W 56/005; H04W 56/0035

(57) ABSTRACT

Provided is a positioning method performed by a node device receiving a positioning reference signal transmitted from another node device, wherein the positioning reference signal comprises a time error and a propagation delay. The positioning method includes determining, a synch-vector based on the time error and the propagation delay, wherein the synch-vector is configured to remove the time error or the propagation delay. Further, the positioning method includes applying the synch-vector to generate a synchronized positioning reference signal that corrects for the time error or the propagation delay. The positioning method can also include determining an unknown integer number of carrier wavelengths based on a phase difference value of the synchronized positioning reference signal, the time error, and the propagation delay.

### INCORPORATION BY REFERENCE TO ANY PRIORITY APPLICATIONS

Any and all applications for which a foreign or domestic priority claim is identified in the Application Data Sheet as filed with the present application are hereby incorporated by reference under 37 CFR 1.57.

### BACKGROUND

### Field

The present disclosure of the following description relates to a method and apparatus for obtaining distance information using signal phase information in a positioning method via a radio signal. More specifically, the method and apparatus for obtaining accurate distance information using phase information of a round-trip signal between vehicles is disclosed.

### Description of the Related Art

Vehicle to everything (V2X) is a communication system where a vehicle is equipped with the capability to recognize and communicate simultaneously with various systems including but not limited to vehicle to network (V2N), vehicle to infrastructure (V2I), vehicle to vehicle (V2V), vehicle to cloud (V2C), vehicle to pedestrian (V2P), vehicle to device (V2D), and vehicle to grid (V2G).

A communication system may include a core network (e.g., a mobility management entity (MME), a serving gateway (SGW), a packet data network (PDN) gateway (PGW), etc.), a base station (e.g., a macro base station, a small base station, a relay, etc.), a user equipment (UE), and the like. Communication between the base station and the UE may be performed using a variety of radio access technology (RAT), for example, 4-th generation (4G) communication technology, 5-th generation (5G) communication technology, wireless broadband (WiBro) technology, wireless local area network (WLAN) technology, and wireless personal area network (WPAN) technology.

In a communication system, a User Equipment (UE) may generally transmit and receive data through a base station. For example, if data to be transmitted to a second UE is present, a first UE may generate a message including the data to be transmitted to the second UE and may transmit the generated message to a first base station to which the first UE belongs. The first base station may receive the message from the first UE and may verify that a destination of the received message is the second UE. The first base station may transmit the message to a second base station to which the verified destination, that is, the second UE belongs in a second base station sum time interval. The second base station may receive the message from the first base station and may verify that the destination of the received message is the second UE. The second base station may transmit the message to the verified destination, that is, the second UE. The second UE may receive the message from the second base station and may acquire the data included in the received message.

A UE and a base station may mutually transmit and receive reference signals. As another example, different two base stations may exchange reference signals with each other. A reference signal may be used for various purposes. For example, a UE or a base station may perform synchronization or estimate a position of the UE based on the reference signal. As one of positioning methods using RAT, the UE may perform positioning based on a difference in time of arrival between positioning reference signals (PRSs) received at the UE from a plurality of base stations or a reception phase difference of a reference signal.

In the case of performing positioning based on the reception phase difference of the reference signal, an integer ambiguity issue may occur. The smaller a wavelength of the reference signal is set, a positioning precision for a phase or a phase difference may be improved. On the contrary, a period of a corresponding phase value or a corresponding phase difference may become ambiguous. That is, as the positioning precision for the phase or the phase difference is improved, it becomes increasingly difficult to determine the integer ambiguity.

### SUMMARY

In some aspects, the methods described herein relate to a positioning method performed by a node device, the positioning method including: receiving, by a first node device, a positioning reference signal transmitted from a second node device, wherein the positioning reference signal includes a time error and a propagation delay; determining, by the first node device, a synch-vector based on the time error and the propagation delay, wherein the synch-vector is configured to remove at least one of the time error or the propagation delay from the positioning reference signal; and applying, by the first node device, the synch-vector to the positioning reference signal to generate a synchronized positioning reference signal, wherein the synchronized positioning reference signal includes the positioning reference signal corrected for the time error or the propagation delay.

In some aspects, the methods described herein relate to a positioning method, wherein the second node device determines a position of the first node device based on the synchronized positioning reference signal transmitted by the first node device.

In some aspects, the methods described herein relate to a positioning method, wherein the positioning reference signal includes a plurality of subcarriers, the method further including determining phase difference information based on frequencies of the plurality of subcarriers, and wherein the phase difference information includes a phase vector based on a wavelength or a frequency of at least one subcarrier among the plurality of subcarriers.

In some aspects, the methods described herein relate to a positioning method, wherein determining the synch-vector is further based on the phase difference information, wherein the phase difference information further includes a carrier phase difference information or a subcarrier phase difference information.

In some aspects, the methods described herein relate to a positioning method, further including converting the phase difference information into a phase difference value by applying an argument angle function by: determining a carrier phase difference value by applying a first argument angle function to the phase vector; and determining a subcarrier phase difference value by applying a second argument angle function to a conjugate multiplication of the phase vector.

In some aspects, the methods described herein relate to a positioning method, wherein at least one of the first node device or the second node device includes a vehicle.

In some aspects, the methods described herein relate to a positioning method, further including: receiving, by a third node device, a second positioning reference signal transmitted from the second node device; and selecting one of the first node device, the second node device, or the third node device to be a server node and others of the first node device, the second node device, or the third node device to be client nodes.

In some aspects, the methods described herein relate to a positioning method, further including: receiving, by a third node device, a second positioning reference signal transmitted from the second node device; and selecting the second node device to be a server node and the first node device and the third node device to be client nodes.

In some aspects, the methods described herein relate to a positioning method, wherein: each of the client nodes determine a client-specific synch-vector configured to remove client-specific time error and client-specific propagation delay from the positioning reference signal received by the client node; each of the client nodes applies the client-specific synch-vector to the positioning reference signal to generate a client-specific synchronized positioning reference signal, wherein the client-specific synchronized positioning reference signal includes the client-specific positioning reference signal corrected for the client-specific time error and the client-specific propagation delay; and each of the client nodes transmits the client-specific synchronized positioning reference signal to the server node, wherein the server node determines a client-specific position for each of the client nodes based on the client-specific synchronized positioning reference signals.

In some aspects, the methods described herein relate to a positioning method performed by a node device, the positioning method including: receiving, by a first node device, a positioning reference signal transmitted from a second node device; and determining an unknown integer number of carrier wavelengths based on a phase difference value of a synchronized positioning reference signal, a time error, and a propagation delay.

In some aspects, the methods described herein relate to a positioning method, wherein the synchronized positioning reference signal is generated by: receiving, by the first node device, a positioning reference signal transmitted from a second node device, wherein the positioning reference signal includes a time error and a propagation delay; determining, by the first node device, a synch-vector based on the time error and the propagation delay, wherein the synch-vector is configured to remove at least one of the time error or the propagation delay from the positioning reference signal; and applying, by the first node device, the synch-vector to the positioning reference signal to generate the synchronized positioning reference signal, wherein the synchronized positioning reference signal includes the positioning reference signal corrected for the time error or the propagation delay.

In some aspects, the methods described herein relate to a positioning method, further including: determining, by the second node device, a position of the first node device based on the unknown integer number of carrier wavelengths; determining, by the second node device, a position of the second node device based on the unknown integer number of carrier wavelengths.

In some aspects, the methods described herein relate to a positioning method, further including: receiving, by a third node device, a second positioning reference signal transmitted from the second node device; and selecting the second node device to be a server node and the first node device and the third node device to be client nodes.

In some aspects, the methods described herein relate to a positioning method, wherein the client nodes transmit synchronized positioning reference signals based on the positioning reference signal from the server node.

In some aspects, the methods described herein relate to a positioning method, wherein: each of the client nodes determine a client-specific synch-vector configured to remove client-specific time error and client-specific propagation delay from the positioning reference signal received by the client node; each of the client nodes applies the client-specific synch-vector to the positioning reference signal to generate a client-specific synchronized positioning reference signal, wherein the client-specific synchronized positioning reference signal includes the client-specific positioning reference signal corrected for the client-specific time error and the client-specific propagation delay; and each of the client nodes transmits the client-specific synchronized positioning reference signal to the server node, wherein the server node determines a client-specific position for each of the client nodes based on the client-specific synchronized positioning reference signals.

In some aspects, the methods described herein relate to a positioning method, further including: determining a first synch-vector for the first client node; and determining a second synch-vector of the second client node.

In some aspects, the methods described herein relate to a positioning method, wherein the client-specific synchronized positioning reference signal includes 2m subcarriers and time variables of first to mth subcarriers depend on a local time of each of the client nodes, wherein the time variables of first to mth subcarriers do not depend on a local time of the server node.

In some aspects, the methods described herein relate to a positioning method, wherein each of the client nodes and the server node determine full-mesh UE-to-UE distance information based on a RTP server method in order of 2n message exchanges.

In some aspects, the methods described herein relate to a positioning method, further including: generating, by the server node, a synch-vector based on propagation delay between the server node and each of the client nodes; calculating, by the server node, a propagation delay broadcast signal sequence using the synch-vector and a signal generation vector for generating a propagation delay broadcast signal; and transmitting, by the server node, the propagation delay broadcast signal using the propagation delay broadcast signal sequence.

In some aspects, the methods described herein relate to a positioning method, further including: setting first to mth components of a synch-vector based on propagation delay between the server node and each of the client nodes to a same constant; and setting km+1th to (k+1)mth components of the synch-vector based on propagation delay to complex numbers having a phase depending on a path delay time between a kth node and a first node.

### BRIEF DESCRIPTION OF THE DRAWINGS

FIG. 1 is a conceptual diagram illustrating a communication system according to an exemplary embodiment.

FIG. 2 is a conceptual diagram illustrating a synch-vector.

FIG. 3 is a state diagram showing the election process of a RTP server according to an exemplary embodiment.

FIG. 4 is a conceptual diagram illustrating a communication system according to another exemplary embodiment.

FIG. 5 is a conceptual diagram illustrating a communication system according to another exemplary embodiment.

FIG. 6A is a conceptual diagram showing the configuration of a communication node constituting a communication system by way of example.

FIG. 6B is a block diagram showing the configuration of a communication node constituting a communication system by way of example.

FIG. 7 is a conceptual diagram illustrating a RTP method according to an exemplary embodiment.

FIG. 8 is a conceptual timing diagram illustrating a RTP method according to an exemplary embodiment.

### DETAILED DESCRIPTION

Various modifications and changes may be made to the present disclosure and the disclosure may include various example embodiments. Specific example embodiments are described in detail with reference to the accompanying drawings. The example embodiments, however, may be embodied in various different forms, and should not be construed as being limited to only the specific example embodiments. Rather, the example embodiments should be understood to include all of the modifications, equivalents, and substitutions included in the spirit and technical scope of the disclosure. Although the terms “first,” “second,” etc., may be used herein to describe various components, the components should not be limited by these terms. These terms are only used to distinguish one component from another component. For example, a first component may also be termed a second component and, likewise, a second component may be termed a first component, without departing from the scope of this disclosure. As used herein, the term “and/or” includes any and all combinations of one or more of the associated items.

When a component is referred to as being “connected to” or “coupled to” another component, the component may be directly connected to or coupled to the other component, or one or more other intervening components may be present. In contrast, when a component is referred to as being “directly connected to” or “directly coupled to,” there is no intervening component.

The terms used herein are used to simply explain specific example embodiments and are not construed to limit the present disclosure. The singular forms “a,” “an,” and “the,” are intended to include the plural forms as well, unless the context clearly indicates otherwise. It will be further understood that the terms “comprises/comprising (incudes/including),” and “has/having” when used in this specification, specify the presence of stated features, integers, steps, operations, elements, and/or components, but do not preclude the presence or addition of one or more other features, integers, steps, operations, elements, components, and/or groups, thereof.

Unless otherwise defined, all terms (including technical and scientific terms) used herein have the same meaning as commonly understood by one of ordinary skill in the art to which example embodiments belong. Terms, such as those defined in commonly used dictionaries, should be interpreted as having a meaning that is consistent with their meaning in the context of the relevant art and/or this disclosure, and should not be interpreted in an idealized or overly formal sense unless expressly so defined herein. Hereinafter, example embodiments will be described in detail with reference to the accompanying drawings. For simplicity of description and general understanding of the disclosure, like reference numerals refer to like components throughout the present specification although they are illustrated in different drawings.

Herein, although it is described that a reference signal is used for positioning method of a user equipment (UE) or a node device, it is provided as an example only. The reference signal may be used for synchronization of a UE, node device, or a base station. Also, although description is made based on an example in which the base station transmits a reference signal to the UE, the UE may transmit the reference signal to the base station.

A method of obtaining distance information using signal phase information between devices that exchange radio signals is described. Using this method, precise time synchronization between wireless devices can be achieved and/or accurate location information of other devices can be obtained. When this technology is applied to vehicle-to-vehicle wireless communication, it is possible to acquire the precise location information of another vehicle using signal phase information. In some examples, the acquired phase information and location can be useful for autonomous driving.

A signal measurement method called RTT (Return Trip Time) is a method of capturing the signal round-trip time while exchanging signals of a special pattern between two wireless devices. It can also be used to obtain distance information between two wireless devices using the measured signal round-trip time. In conventional RTT methods, a signal arrival time error, otherwise known as the distance measurement error, is associated with the wireless bandwidth used. To increase signal measurement precision, a wide radio bandwidth must be used.

A wireless service bandwidth of about 20 MHz to 30 MHz is generally allocated for vehicle communication service. In one example, the sampling interval for a system using a 30 MHz bandwidth is approximately 33 nanoseconds. When the sampling interval is measured in nanoseconds and is eventually converted into a distance error, it is difficult for vehicle wireless devices using the RTT method to improve the distance measurement error to a distance of 10 meters or less. For example, the wireless service bandwidth allocated for vehicle communications service is a short signal where the wavelength of the carriers is shorter, resulting in a higher frequency. In order to better understand the information of the signals transmitted from one vehicle to another, the signals must be converted into a lower frequency (i.e., subcarriers) such that the vehicles can accurately measure location information. By acquiring phase information of the carriers and subcarriers, the wireless devices may be synched to remove or correct distance errors. Therefore, precise time synchronization and distance measuring within 1 meter accuracy are required to enhance the safety of autonomous vehicles.

In the present disclosure, methods of exchanging carrier signal phase information between wireless devices will be described. In a reference signal, the wavelength of the carrier wave is only in an order of tens of centimeters. While the wavelength of the carrier wave is short, by measuring the phase of the carrier, it is possible to increase the accuracy of distance measurement within an error range of several tens of centimeters. However, the carrier wave has an unknown integer problem or ambiguity such that the wireless devices and transmitters have difficulty knowing the carrier wavelength to be measured. In the present application, a method of obtaining carrier and subcarrier phase value or information using a reference signal is disclosed. Furthermore, measuring distance information by solving the unknown integer problem will be described.

According to at least one embodiment, if a distance is measured using a radio carrier signal within a given bandwidth limit, time and position measurements can be more precise than the conventional RTT method.

In the present disclosure, node devices or nodes may refer to base stations for wireless communication including but not limited to transmission and reception point (TRP) device, gNodeB/Next-Generation Node B (gNB) device, or RSU (Road Side Unit) roadside device, vehicle base station devices, or mobile vehicle wireless devices. These node devices exchange a reference symbol for positioning called PRS (Positioning Reference Symbol) or RTP (Return Trip Phase). The phase information of this reference symbol is used to determine the relationship between node devices. The node devices in any communication system may elect server nodes or anchor nodes. The Server nodes may be capable of transmitting PRS reference signals and requesting RTP signals from other node devices. The node devices not elected or selected as Server nodes may be referred to as Client nodes, or client-specific nodes. The Client nodes may not be capable of transmitting PRS reference signals and transmit RTP signals based on a request from a Server node. The present disclosure discloses synchronize timing and measuring methods for the distance between nodes.

In the present disclosure, concepts related to a synch-vector, time error, propagation delay, positioning reference signal may all be associated with a certain type of nodes such as server node devices or client node devices. For example, concepts associated with a client node device may be referred to as client-specific synch-vector, client-specific time error, client-specific propagation delay, client-specific positioning reference signals, client-specific synchronized positioning reference signals, and the likes thereof.

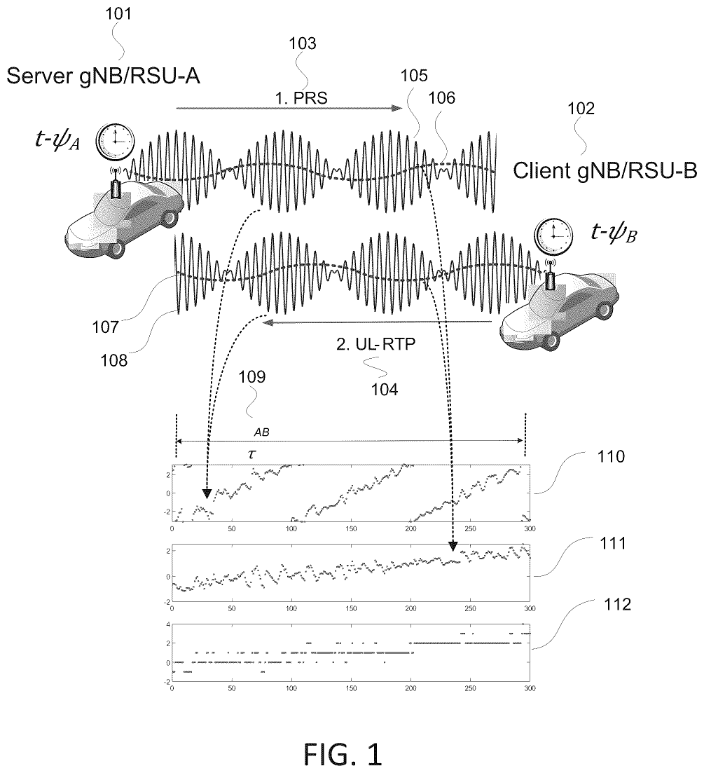

FIG. 1 is a conceptual diagram illustrating a communication system according to an exemplary embodiment. In the exemplary embodiment, a transmitting node or a Server gNB/RSU-A 101 may transmit a PRS reference signal 103 to a receiving node or a Client gNB/RSU-B 102. The PRS reference signal 103 may comprise carrier waveforms 105 and subcarrier waveforms 106. In any embodiment, the node devices may comprise a time error and a propagation delay 109. The Client gNB/RSU-B 102 may demodulate or decompose the PRS reference signal 103 into carrier waveforms 105 and subcarrier waveforms 106 to extract phase difference information between the two node devices. The phase difference information may further comprise a carrier phase difference information 110 and a subcarrier phase difference information 111. The phase difference information for any of the carriers or subcarriers may be converted into carrier phase difference value and subcarrier phase difference value to help determine an unknown integer number of carrier wavelengths. For example, by using the extracted phase difference information 110, 111 and by adjusting the propagation delay 109, an unknown integer number of carrier wavelengths 112 may be determined. Solving for the unknown integer number of carrier wavelengths 112 will accurately inform the Server gNB/RSU-A 101 with position information. In this exemplary embodiment, using the unknown integer number of carrier wavelengths, the Client gNB/RSU-B 102 may modulate the reference signal back into an up-link UL-RTP signal 104 to send to the Server gNB/RSU-A 101. Likewise, the UL-RTP signal may comprise RTP subcarrier waveforms 107 and RTP carrier waveforms 108.

In some embodiments, a communication system may comprise of a receiving node or a first node device, and a transmitting node or a second node device. These node devices generate a sample number associated with radio signals. The radio signals include clock devices known as internal oscillators. The rate at which these sample numbers are generated depends on a pre-configured sample rate. The sample number generated internally by these node devices may be a multiple of the orthogonal frequency division multiplexing (OFDM) symbol size or a multiple of the FFT window length. In general, an OFDM transmission method is used to describe that a reference signal is discontinuous in a boundary between symbols. For example, in a typical OFDM system, a value of N may be determined based on a size of a fast Fourier transform (FFT) window. In Equation 1, t is the sample time, N is the FFT window size (e.g., 4096), Ts is the sample time interval, and k, n are random integers.

$$t = {t}_{s a m p l e} + k * N = ( n + k * N ) * {T}_{s} \qquad [ Equation 1 ]$$

PRS reference signal sequence, sₐ(t), transmitted by the second node device is a frequency domain complex index as represented in Equation 2. The PRS reference signal or sequence, expressed as a form of a carrier waveform when transmitted, can also be expressed in the form of a subcarrier. The reference signals transmitted by a second node device and received by a first node device may include a subcarrier group that includes subcarriers provided at equal intervals in a frequency domain. In Equation 2, t, represents the ideal perfect time in which the reference signal is transmitted. Since transmitter clocks of the node devices are not aligned, there is always a time error of the order of ψ_{A}. Therefore, t−ψ_{A} denotes the local time of the first node device which includes the time error.

In a plurality of OFDM symbols, the respective subcarrier components may be orthogonal to each other. In an OFDM symbol, a signal may be represented as a sum of complex sine waves. In Equation 2, ω₁, ω₂ . . . represent frequencies of a subcarrier number arranged at m equal intervals, where ω_{q}(=2πq/N), where N is the FFT size, q is the number of subcarriers. Positioning performance of nodes may depend on the phase positioning precision of each node. As a result, it is challenging for nodes to calculate a phase difference between reference signals. Since a codomain of the phase difference is −π to π (or 0 to 2π), an integer ambiguity issue may also occur.

Each subcarrier comprises a wavelength or frequency. The subcarrier spacing or subcarrier gap frequency may be represented by ω_{g}. Therefore, the frequency of the mth subcarrier is ω₁+(m−1)*ω_{g}. A₁, A₂, . . . Aₘ is the initial complex coefficient given to each subcarrier, where Ag denotes a modulated strength component of a subcarrier signal having an angular frequency ω_{q}. If the receiving node knows the coefficient sequence of the transmitted PRS reference signal, the coefficient component received from one of the second node's reference signal may be removed.

$${s}_{a} ( t ) = {A}_{1} {e}^{j {ω}_{1} ( t - {ψ}_{A} )} + {A}_{2} {e}^{j {ω}_{2} ( t - {ψ}_{A} )} + … + {A}_{m} {e}^{j {ω}_{m} ( t - {ψ}_{A} )} = {\sum }_{q = 1}^{m} {A}_{q} {e}^{j {ω}_{q} ( t - {ψ}_{A} )} \qquad [ Equation 2 ]$$

The PRS reference signal, sₐ(t), is an OFDM symbol composed of a plurality of subcarrier symbols. When a plurality of subcarrier symbols is connected and transmitted, this subcarrier waveform may be a continuous signal over several PRS symbols. For example, sₐ(t) denotes the reference signal or baseband signal modulated to a passband signal where the second node device may transmit the reference signal sample sequence of Equation 2 at a transmission frequency or angular frequency of a carrier, ω_{c}. A baseband signal is the original frequency where data travels through only one communication channel available at any time. A passband signal refers to a filtered signal where the frequency or phase of the carrier signals may be modulated to transmit bits of the data. This passband signal will change the property of the carrier wave such as its frequency or amplitude, allowing transmission at a higher frequency used for longer distance transmissions. Thus, the original reference baseband signal may be up-converted into a passband signal as represented in Equation 3.

$${PRS}_{Apass} ( t ) = {e}^{j {ω}_{c} ( t - {ψ}_{A} )} \cdot {s}_{a} ( t ) = {\sum }_{q = 1}^{m} {A}_{q} {e}^{j ( {ω}_{c} + {ω}_{q} ) ( t - {ψ}_{A} )} \qquad [ Equation 3 ]$$

In Equation 3, (ω_{c}+ω_{q}) is the passband frequency corresponding to the sum of the carrier frequency and the subcarrier frequency. PRS reference signals as displayed in Equation 3 can be broadcast periodically. An up-converted passband signal shifts the frequency of the signal to a higher frequency which can make the signal easier to transmit over long distances or through certain types of media.

Once the reference signal is shifted to a higher frequency, the reference signal may be transmitted through a travel path from one node device to another node device. In Equation 4, (ω_{c}+ωₖ) represents the sum of carrier and subcarrier frequencies. H_{A} represents the signal magnitude component while h₀, h₁, h₂ are the signal magnitude component of each travel path. Travel paths are generally mutually uncorrelated (i.e., each travel path may not be straight or direct). Given this, τ_{A} can be represented as the first path delay while τₐ₁, τₐ₂ can represent the relative delay time difference of the remaining paths.

$${H}_{A} ( {ω}_{c} + {ω}_{k} ) = {h}_{0}^{a} {e}^{- i ( {ω}_{c} + {ω}_{k} ) {τ}_{A}} + {h}_{1}^{a} {e}^{- i ( {ω}_{c} + {ω}_{k} ) ( {τ}_{A} + {τ}_{a 1} )} + {h}_{2}^{a} {e}^{- i ( {ω}_{c} + {ω}_{k} ) ( {τ}_{A} + {τ}_{a 2} )} + … {h}_{l}^{a} {e}^{- i ( {ω}_{c} + {ω}_{k} ) ( {τ}_{A} + {τ}_{a l} )} = {\sum }_{p = 0}^{l} {h}_{p}^{a} {e}^{- i ( {ω}_{c} + {ω}_{k} ) ( {τ}_{A} + {τ}_{a p} )} \qquad [ Equation 4 ]$$

Modifying Equation 4 for simplicity yields Equation 5. In Equation 5, P_{A}(ω_{c}+ωₖ) is denoted as the remaining paths. A channel path limits the number of carriers and subcarriers that can travel through the channel. The relative delay values of the remaining paths except for TA are expressed as a complex exponential sum.

$${H}_{A} ( {ω}_{c} + {ω}_{k} ) = {e}^{- i ( {ω}_{c} + {ω}_{k} ) {τ}_{A}} ( {h}_{0}^{a} + {h}_{1}^{a} {e}^{- i ( {ω}_{c} + {ω}_{k} ) {τ}_{a 1}} + {h}_{2}^{a} {e}^{- i ( {ω}_{c} + {ω}_{k} ) {τ}_{a 2}} + … {h}_{l}^{a} {e}^{- i ( {ω}_{c} + {ω}_{k} ) {τ}_{a l}} ) = {e}^{- j ( {ω}_{c} + {ω}_{k} ) {τ}_{A}} {P}_{A} ( {ω}_{c} + {ω}_{k} ) \qquad [ Equation 5 ]$$

In some examples, the signal sequence may arrive at a receiving node device or other node devices through the channel represented in Equation 5. This reference signal may be expressed in Equation 6.

$$P R {S}_{Ach} ( t ) = {\sum }_{q = 1}^{m} {H}_{A} ( {ω}_{c} + {ω}_{q} ) {A}_{q} {e}^{j ( {ω}_{c} + {ω}_{q} ) ( t - {ψ}_{A} )} = {\sum }_{q = 1}^{m} {P}_{A} ( {ω}_{c} + {ω}_{q} ) {A}_{q} {e}^{j ( {ω}_{c} + {ω}_{q} ) ( f - {ψ}_{A} - {τ}_{A} )} \qquad [ Equation 6 ]$$

In order to extract phase difference information, the reference signal may be down-converted into a baseband by multiplying the inverse carrier component in the radio frequency (RF) mixer of the receiving node. A down conversion converts the signal to a lower frequency which can make the signal easier to process and demodulate. For example, the receiving node may convert the passband reference signal to a baseband signal. yₐ(t) in Equation 7 represents a result of converting the passband signal received at the receiving node to the baseband signal. The receiver clock error is denoted by ψ_{R} that occurs due to a mismatch between the receiving node and the transmitting node.

$${y}_{a} ( t ) = {e}^{- j {ω}_{c} ( t - {ψ}_{R} )} \cdot {PRS}_{Ach} ( t ) = {\sum }_{q} {P}_{A} ( {ω}_{c} + {ω}_{q} ) {A}_{q} {e}^{j ( {ω}_{c} ( {ψ}_{R} - {ψ}_{A} - {τ}_{A} ) + {ω}_{q} ( t - {ψ}_{A} - {τ}_{A} ) )} \qquad [ Equation 7 ]$$

In Equation 7, after taking N time received sample sequences or signals and converting the sample signals via FFT or discrete Fourier transform (DFT), the frequency domain subcarriers described in complex exponential phase vector or vector, [symbol] ₐ, may be shown in Equation 8. For example, the baseband signal acquired by collecting the reference signal as N sample sequences may be expressed as sample vectors. In a typical OFDM system, N may be determined based on the size of an FFT window. Based on the sample vectors, a phase vector, [symbol] ₐ, may be calculated using Equation 8.

$${𝕐}_{a} = N \cdot [ \begin{matrix}\begin{matrix}{{P}_{A} ( {ω}_{c} + {ω}_{1} )}^{{e}^{j ( {ω}_{c} + {ω}_{1} ) ( {ψ}_{R} - {ψ}_{A} - {τ}_{A} )}} \\ {P}_{A} ( {ω}_{c} + {ω}_{2} ) {e}^{j ( {ω}_{c} + {ω}_{2} ) ( {ψ}_{R} - {ψ}_{A} - {τ}_{A} )}\end{matrix} \\ ⋮ \\ {P}_{A} ( {ω}_{c} + {ω}_{m} ) {e}^{j ( {ω}_{c} + {ω}_{m} ) ( {ψ}_{R} - {ψ}_{A} - {τ}_{A} )}\end{matrix} ] + {σ}_{A} \qquad [ Equation 8 ]$$

In Equation 8, a PRS symbol initial sequence of A₁, A₂, . . . Aₘ may be presumed to be known and therefore removed. σ_{A} is a noise interference vector component or an error vector due to FFT/DFT operation. P_{A}(ω_{c}+ωₖ) represents the relative delay values of the remaining paths except for the first channel path τ_{A} and is expressed as a complex exponential sum. In the case of a Rician channel with a strong line-of-sight (LoS) component, the phase component of P_{A}(ω_{c}+ωₖ) may approach 0 as shown in Equation 9. A Rician channel may consider that a signal has a dominant LoS component and a random non-line-of-sight (NLoS) component. The LoS component is known to be the direct path from the transmitter to the receiver, which has a constant amplitude and phase.

$$arg ( {P}_{A} ( {ω}_{c} + {ω}_{k} ) ) = arg ( {h}_{0}^{a} + {h}_{1}^{a} {e}^{- i ( {ω}_{c} + {ω}_{k} ) {τ}_{a 1}} + {h}_{2}^{a} {e}^{- i ( {ω}_{c} + {ω}_{k} ) {τ}_{a 2}} + … {h}_{l}^{a} {e}^{- i ( {ω}_{c} + {ω}_{k} ) {τ}_{al}} ) ≅ 0 \qquad [ Equation 9 ]$$

Next, applying the argument function known as the arg (angle) function to the sum of all the complex exponentials of the [symbol] ₐ phase vector, yields the carrier phase difference value as represented in Equation 10.

$$arg ( sum ( {𝕐}_{a} ) ) ≅ arg ( {e}^{j ( {ω}_{c} + {ω}_{Δ} ) ( {ψ}_{R} - {ψ}_{A} - {τ}_{A} )} ) = ( {ω}_{c} + {ω}_{Δ} ) ( {ψ}_{R} - {ψ}_{A} - {τ}_{A} ) - 2 π {N}_{c} \qquad [ Equation 10 ]$$

In Equation 10, ω_{Δ} is the center frequency of the subcarrier set 1 to subcarrier set m (first to mth components or first to mth subcarriers). Since [symbol] ₐ(t) is a periodic signal, the phase value of arg(sum( [symbol] )) is repeated every [symbol] times 2π. Therefore, to exactly determine the value of this phase difference, the unknown integer number [symbol] must be known. In order to determine or calculate [symbol] (carrier phase unknown integer number), the lower m−1 subvector and the upper m−1 subvector in the subcarrier vector [symbol] ₐ is conjugated. Note that the subcarrier gap frequency of the vectors is all denoted by ω_{g}.

$${𝕐}_{a} {𝕐}_{a}^{*} = N \cdot [ \begin{matrix}{P}_{A} ( {ω}_{c} + {ω}_{2} ) {e}^{j ( {ω}_{c} + {ω}_{2} ) ( {ψ}_{R} - {ψ}_{A} - {τ}_{A} )} \\ {P}_{A} ( {ω}_{c} + {ω}_{3} ) {e}^{j ( {ω}_{c} + {ω}_{3} ) ( {ψ}_{R} - {ψ}_{A} - {τ}_{A} )} \\ ⋮ \\ {P}_{A} ( {ω}_{c} + {ω}_{m} ) {e}^{j ( {ω}_{c} + {ω}_{m} ) ( {ψ}_{R} - {ψ}_{A} - {τ}_{A} )}\end{matrix} ] ⊙ N \cdot [ \begin{matrix}{P}_{A}^{*} ( {ω}_{c} + {ω}_{1} ) {e}^{- j ( {ω}_{c} + {ω}_{1} ) ( {ψ}_{R} - {ψ}_{A} - {τ}_{A} )} \\ {P}_{A}^{*} ( {ω}_{c} + {ω}_{2} ) {e}^{- j ( {ω}_{c} + {ω}_{2} ) ( {ψ}_{R} - {ψ}_{A} - {τ}_{A} )} \\ ⋮ \\ {P}_{A}^{*} ( {ω}_{c} + {ω}_{m - 1} ) {e}^{- j ( {ω}_{c} + {ω}_{m - 1} ) ( {ψ}_{R} - {ψ}_{A} - {τ}_{A} )}\end{matrix} ] = {N}^{2} \cdot [ \begin{matrix}{P}_{A} ( {ω}_{c} + {ω}_{2} ) {P}_{A}^{*} ( {ω}_{c} + {ω}_{1} ) {e}^{j ( {ω}_{2} - {ω}_{1} ) ( {ψ}_{R} - {ψ}_{A} - {τ}_{A} )} \\ {P}_{A} ( {ω}_{c} + {ω}_{3} ) {P}_{A}^{*} ( {ω}_{c} + {ω}_{2} ) {e}^{j ( {ω}_{3} - {ω}_{2} ) ( {ψ}_{R} - {ψ}_{A} - {τ}_{A} )} \\ ⋮ \\ {P}_{A} ( {ω}_{c} + {ω}_{m} ) {P}_{A}^{*} ( {ω}_{c} + {ω}_{m - 1} ) {e}^{j ( {ω}_{m} - {ω}_{m - 1} ) ( {ψ}_{R} - {ψ}_{A} - {τ}_{A} )}\end{matrix} ] \qquad [ Equation 11 ]$$

In Equation 11, the mathematical function, ⊙, represents the Kronecker multiplication operation between the subvector [symbol] ₐ and conjugate of subvector [symbol] . By applying the Kronecker multiplication operation between the remaining paths P_{A}(ω_{c}+ωₖ) , the imaginary components of the subcarrier vectors cancel each other out, and eventually the phase value converges to almost or approximately zero. It is also presumed that the difference of subcarrier frequencies (ωₖ₊₁−ωₖ) and its neighboring subcarrier frequencies is the equally spaced frequency gap ω_{g}, as seen in Equation 12.

$${ω}_{k + 1} - {ω}_{k} = ( {ω}_{1} + k {ω}_{g} ) - ( {ω}_{1} + ( k - 1 ) {ω}_{g} ) = {ω}_{g} \qquad [ Equation 12 ]$$

Therefore, the phase component of the subcarrier gap frequency ω_{g} can be obtained by taking the arg (angle) function for the difference of vector [symbol] ₐ. The argument angle function converts the set of complex exponential vectors into an integer.

$$arg ( sum ( {𝕐}_{a} {𝕐}_{a}^{*} ) ) ≅ arg ( {e}^{j {ω}_{g} ( {ψ}_{R} - {ψ}_{A} - {τ}_{A} )} ) = {ω}_{g} ( {ψ}_{R} - {ψ}_{A} - {τ}_{A} ) - 2 {π𝒩}_{g} \qquad [ Equation 13 ]$$

In Equation 13, the output of the argument angle function provides a variable, [symbol] , which is an unknown integer number related to the subcarrier gap frequency ω_{g}. If the gap frequency ω_{g} is sufficiently small and the distance between the transmitter is less than half a wavelength, the unknown constant [symbol] may converge to 0 and be ignored. Therefore, by transforming Equation 13, the time error and delay information may be calculated using the gap frequency ω_{g}.

$${ψ}_{R} - {ψ}_{A} - {τ}_{A} = arg ( sum ( {𝕐}_{a} {𝕐}_{a}^{*} ) ) / {ω}_{g} \qquad [ Equation 14 ]$$

Substituting Equation 14 into Equation 10, the unspecified carrier constant [symbol] , otherwise denoted as the unknown integer may be obtained in Equation 15.

$${𝒩}_{c} = round ( ( {ω}_{c} + {ω}_{Δ} ) ( {ψ}_{R} - {ψ}_{A} - {τ}_{A} ) / 2 π - arg ( sum ( {𝕐}_{a} ) ) / 2 π ) \qquad [ Equation 15 ]$$

$$∴ {𝒩}_{c} = round ⌊ \frac{( {ω}_{c} + {ω}_{Δ} )}{{ω}_{g}} \cdot {ϕ}_{s} / 2 π - {ϕ}_{c} / 2 π ⌋$$

$${ϕ}_{s} = arg ( sum ( {𝕐}_{a} {𝕐}_{a}^{*} ) ) , {ϕ}_{c} = arg ( sum ( {𝕐}_{a} ) )$$

In Equation 15, the round function is a number conversion function to an integer. ω_{g} represents the frequency difference between the subcarrier vectors of the reference signals, (ω_{c}+ω_{g})/ω_{g} represents the ratio between the carrier frequency and the subcarrier gap frequency, ϕₛ represents the subcarrier phase difference calculated by applying Equation 13, and ϕ_{c} represents the carrier phase difference calculated by applying Equation 10.

On the other hand, in Equation 10, ψ_{R}−ψ_{A} represents the initial local time error between the transmitting and receiving nodes. If the transmitting and receiving nodes are fixed, and the distance between them and the path delay τ_{A} are known in advance, the unknown integer [symbol] and the time error between the two nodes can be calculated as represented in Equation 16.

$${ε}_{RA} = {ψ}_{R} - {ψ}_{A} = \frac{arg ( sum ( {𝕐}_{a} ) ) + 2 {π𝒩}_{c}}{{ω}_{c} + {ω}_{Δ}} + {τ}_{A} \qquad [ Equation 16 ]$$

$${𝒩}_{c} = round ( ( {ω}_{c} + {ω}_{Δ} ) {τ}_{A} / 2 π )$$

If the receiving node device has the ability to fine-tune its own oscillator error, the initial error ψ_{R}−ψ_{A} of the transmitter and receiver clocks can be canceled out by setting ε_{RA} to 0, hence, synchronizing the phase between two node devices.

Using Equation 16 above, local time errors of PRS reference signals transmitted by a plurality of gNB/TRP devices having fixed positions can be offset and carrier phases can be synchronized and/or matched.

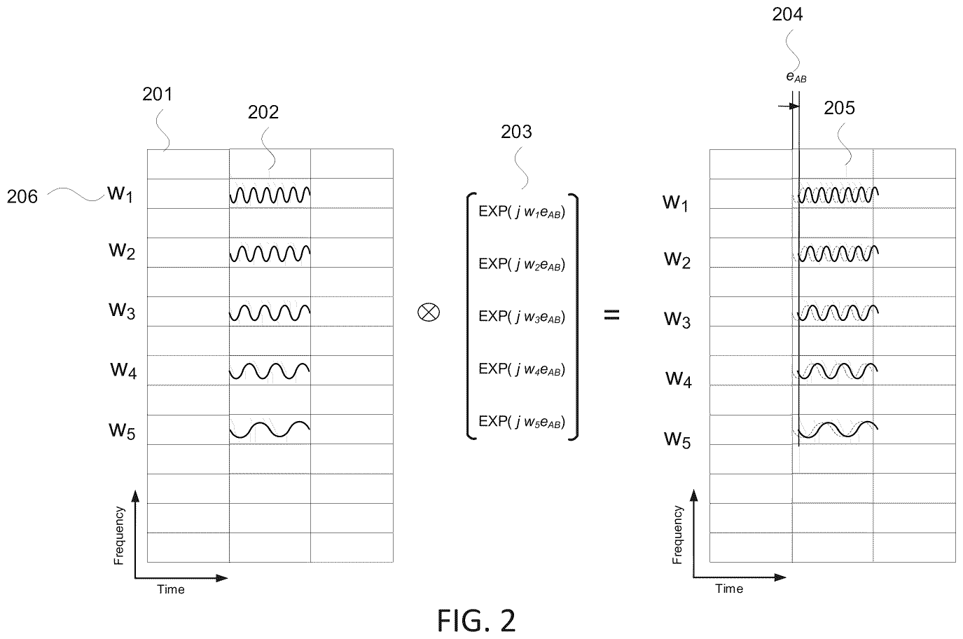

FIG. 2 is a conceptual diagram illustrating a synch-vector. In embodiments where the transmitting and receiving nodes are not fixed, and the distance between the nodes and the path delay are not known in advance, determining the unknown integer associated with the carrier wavelength will require synchronization of the phase differences.

In some embodiments, a reference signal may be represented as an OFDM symbol grid 201 comprising of a plurality of subcarriers or reference symbols 202 with various wavelengths or frequencies 206. A synch-vector 203 may be constructed based on phase difference information and time error 204. By applying the synch-vector 203 to an OFDM symbol grid 201 represented by a complex exponential phase vector, a synchronized phase vector or synchronized reference symbol 205 may be created.

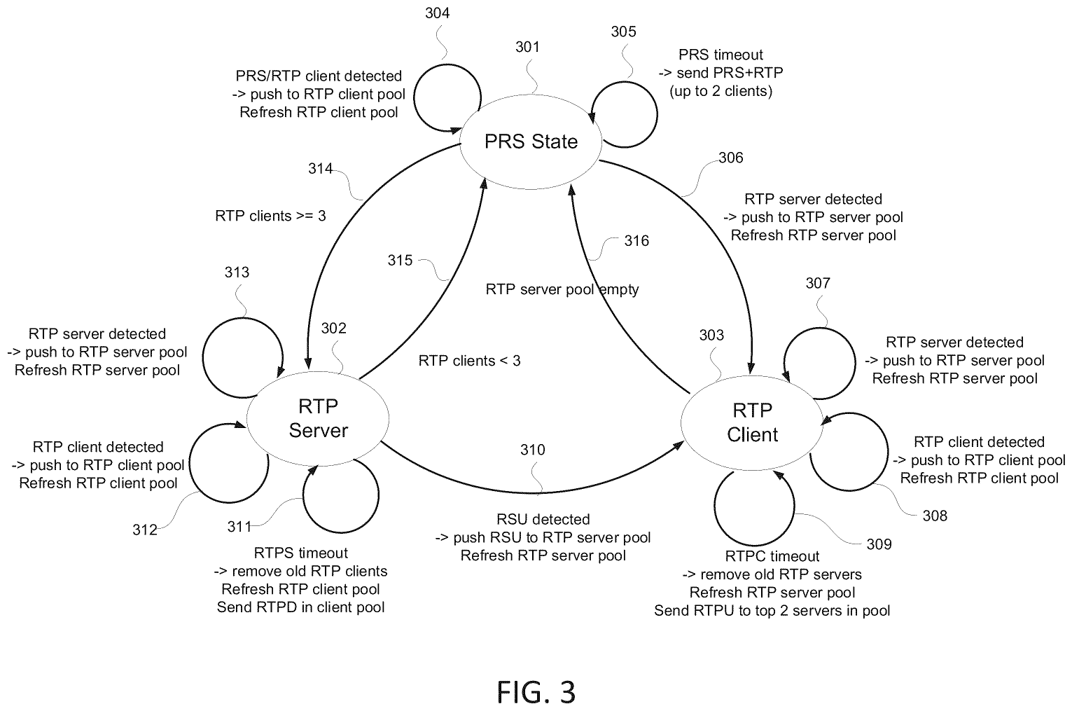

FIG. 3 is a diagram showing the election process of a RTP server according to an exemplary embodiment. In some embodiments, three possible states may be represented by a circle: PRS State 301, RTP Server 302, and RTP Client 303. The arrows denote a transition from one state to another.

The PRS State 301 may have four possible transitions, where in 304, if a PRS/RTP client is detected, it may be pushed into the RTP client pool, and the client pool may be refreshed. In transition 305, the PRS may timeout, sending one or more PRS/RTP signals to the client pool. In transition 314, if more than three RTP clients are detected, the PRS State 301 will be transitioned into the RTP Server 302. In transition 306, if an RTP server is detected, the RTP server will be pushed into a RTP server pool, and the server pool will be refreshed.

The RTP Server 302 may have five possible transitions, where in transition 313, if an RTP server is detected, the RTP server will be pushed into a RTP server pool, and the server pool will be refreshed. In transition 312, if an RTP client is detected, the RTP client will be pushed into a RTP client pool, and the client pool will be refreshed. In transition 310, if a RSU is detected, the RSU will be pushed into a RTP server pool, the server pool will be refreshed, and the RTP Server 302 will be transitioned into the RTP Client 303. In transition 315, if less than three RTP clients are detected, the RTP Server 302 will be transitioned into a PRS State 301. In transition 311, a RTP server may time out to remove old RTP clients from the client pool, refresh the client pool, and send RTPD signal to the client pool.

The RTP Client 303 may have four possible transitions, where in transition 316, if an RTP server pool is empty, the RTP Client 303 will be transitioned into a PRS State 301. In transition 307, if an RTP server is detected, the RTP server will be pushed into a RTP server pool, and the server pool will be refreshed. In transition 308, if an RTP client is detected, the RTP Client 303 will be pushed into a RTP client pool, and the client pool will be refreshed. In transition 309, a RTP Client 303 may time out to remove old RTP servers from the client pool, refresh the server pool, and send RTPU signal to the top two servers in the server pool.

In some embodiments, vehicle nodes may elect a Server and Client Node while exchanging PRS signals between adjacent vehicle nodes. All vehicle nodes may initially claim to be RTP servers in the PRS State 301 and periodically transmit PRS signals in transition 305. If other neighboring nodes in the vicinity receive a PRS signal claiming to be an RTP server as such in transition 306, the neighboring nodes either transfer to RTP Client 303 status according to a separate tie breaker rule (e.g., based on a predetermined parameter or threshold) or simply ignore the signal.

A node that has transitioned to RTP Client 303 must reply to the RTPU signal each time the node receives a PRS signal from the RTP server and respond to whenever a node recognized by the RTP server sends a PRS signal in transition 307. It then receives the PRS or RTPU signal sent by another nearby node in transition 308 and stores the information and uses it in the UE-to-UE path delay calculation process. The RTP Client 303 nodes also store the information of PRS or RTPU signals whenever it receives them from other nearby nodes. The stored neighbor information is used for UE-to-UE path delay calculation process.

If the RTP Client 303 node is no longer using/receiving the PRS from server as in transition 309, it determines that the server is inactive and returns to the PRS State 301 and periodically sends a PRS signal claiming that it can be the RTP Server 302. This transition from RTP Client 303 to PRS State 301 is represented by transition 316.

When the surrounding nodes reply to the RTPU signal that they are the RTP Server in transition 314 for the PRS periodically sent by the PRS State 301, the RTP Server 302 periodically broadcasts the PRS or RTPD signal in transition 311. When it receives a signal sent by other server in transition 313 or client nodes in transition 312 in the vicinity, it stores this information and periodically broadcasts the collected information through RTPD messages to nearby nodes to inform them in transition 311.

In the PRS State 301, if nearby nodes respond with an RTPU signal endorsing it as the RTP Server in transition 304, the node becomes the RTP Server 302 and periodically broadcast PRS or RTPD signals in transition 311. In RTP Server 302, when it receives signals transmitted by other nearby server in transition 313 or client nodes in transition 312, the server node stores this information and periodically broadcast the collected information to nearby nodes through RTPD messages as denoted by transition 311, hence the nearby nodes may calculate the distance information using the RTPD message as denoted in transition 311. The RTP Server 302 may further broadcast the state of the nodes based on the periodically sent PRS signals in transition 315 and RTP Client.

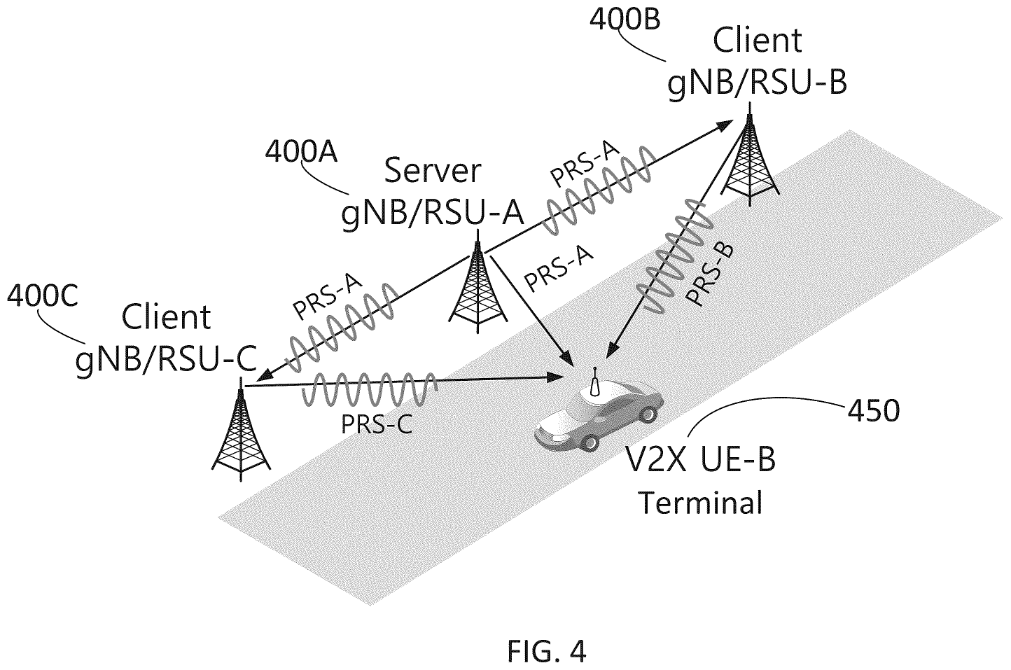

FIG. 4 is a conceptual diagram illustrating a communication system according to an exemplary embodiment. The communication system may include a first base station, a second base station, and a third base station. Each of the first base station, the second base station, and the third base station may also be referred to as a node base (NodeB), a next generation NodeB, an evolved NodeB, gnodeB, a base transceiver station (BTS), a radio base station, a radio transceiver, an access point, an access node, a road side unit (RSU), a radio remote head (RRH), a transmission point (TP), a transmission and reception point (TRP), a relay node, a node, a node device and the like. The V2X UE-B may also be referred to as a terminal 450, an access terminal, a mobile terminal, a station, a subscriber station, a mobile station, a portable subscriber station, a node, a node device, and the like.

Although FIG. 4 illustrates three base stations as an example, it is provided as an example only. The V2X UE-B or terminal 450 may receive a reference signal from four or more base stations during a positioning process. In some embodiments, a plurality of deployed node devices such as gNB/TRP Nodes or roadside RSU devices periodically broadcast PRS reference signals (e.g., PRS-A, PRS-B, and PRS-C). For example, a terminal, V2X UE-B or terminal 450 may receive these PRS reference signals and obtain an accurate location information of terminal 450 based on the phase information of the PRS reference signals. In some embodiments, one of the base stations, such as gNB/RSU-A 400A, may broadcast PRS-A reference signals to gNB/RSU-B 400B and gNB/RSU-C 400C in order to synchronize PRS reference signals PRS-B and PRS-C to terminal or V2X UE-B or terminal 450.

In some embodiments, transmitter clocks and timings of Node devices gNB/RSU-A 400A, gNB/RSU-B 400B, and gNB/RSU-C 400C may not be synchronized, perfect, consistent, or exact. Thus, there may be a natural time error of each transmitter, noted as WA for gNB/RSU-A 400A, ψ_{B} for gNB/RSU-B 400B, and ψ_{C} for gNB/RSU-C 400C, relative to the ideal clock time, t. In one example, t−ψ_{A} may represent the local time of gNB/RSU-A 400A subtracting the ideal clock time, t, from the time error, ψ_{A}. Likewise, t−ψ_{B} may represent the local time of gNB/RSU-B 400B, and t−ψ_{C} may represent the local time of gNB/RSU-C 400C.

With the provided local time of the Nodes, a time domain based on an ideal clock time for each reference signal sequence may be obtained. Acquiring the ideal clock time for each reference signal sequence will help synchronize the reference signal sequences. The time domain PRS-A reference signal sequence sₐ(t) transmitted by gNB/RSU-A 400A may be represented in Equation 17. sₐ(t) may denote a PRS-A reference signal transmitted in the baseband at a time, t, and A_{q} may represent the amplitude and initial phase component of a subcarrier signal having an angular frequency ω_{q}·ω_{q} may indicate m equally spaced subcarriers allocated by node devices. The subcarrier spacing for each node device may be represented by a gap frequency, ω_{g}, and subcarrier frequency, ω_{q}(=2πq/N), where N is the FFT magnitude, q is the number of subcarriers.

Likewise, the PRS-B reference signal sequence transmitted by gNB/RSU-B 400B may be represented as s_{b}(t), and the PRS-C transmitted by gNB/RSU-C 400C may be represented as s_{c}(t). In one example, a node device may acquire a first sample vector from the received data of a first reference signal and may acquire a second sample vector from a received data of a second reference signal. A baseband of the first reference signal transmitted from a node at an ideal time, t may also be represented in Equation 17.

$${s}_{a} ( t ) = {\sum }_{q = 1}^{m} {A}_{q} {e}^{j {ω}_{q} ( t : - {ψ}_{A} )} \qquad [ Equation 17 ]$$

$${s}_{b} ( t ) = {\sum }_{q = 1}^{m} {B}_{q} {e}^{j {ω}_{q} ( t : - {ψ}_{B} )}$$

$${s}_{c} ( t ) = {\sum }_{q = 1}^{m} {C}_{q} {e}^{j {ω}_{q} ( t : - {ψ}_{C} )}$$

Since the local time of the node devices are not yet synchronized, the local time error ψ_{A}, ψ_{B}, and ψ_{C}, may each be included in the complex exponential sum as represented in Equation 17. The baseband signal sample sequences of Equation 17 may be transmitted by each node device at a carrier angular frequency ω_{c}. The baseband signal may be up-converted to a passband signal as expressed in Equation 18.

$$P R {S}_{A p a s s} ( t ) = {e}^{j {ω}_{c} ( 𝔱 - {ψ}_{A} )} \cdot {s}_{a} ( t ) = {\sum }_{q = 1}^{m} {A}_{q} {e}^{j ( {ω}_{c} + {ω}_{q} ) ( 𝔱 - {ψ}_{A} )} \qquad [ Equation 18 ]$$

$$PR {S}_{B p a s s} ( t ) = {e}^{j {ω}_{c} ( 𝔱 - {ψ}_{B} )} \cdot {s}_{b} ( t ) = {\sum }_{q = 1}^{m} {B}_{q} {e}^{j ( {ω}_{c} + {ω}_{q} ) ( 𝔱 - {ψ}_{B} )}$$

$$PR {S}_{C p a s s} ( t ) = {e}^{j {ω}_{c} ( 𝔱 - {ψ}_{c} )} \cdot {s}_{c} ( t ) = {\sum }_{q = 1}^{m} {C}_{q} {e}^{j ( {ω}_{c} + {ω}_{q} ) ( 𝔱 - {ψ}_{C} )}$$

The passband PRS reference signals of the node devices may reach the terminal device or V2X UE-B or terminal 450 through their respective multipath channels, which is also represented in the processes of Equation 4 to Equation 8. For simplicity, it is assumed that each reference signal from the node devices can reach the terminal 450 without collision by applying a time division method or the likes thereof.

In some embodiments, the first reference signal of the passband may either arrive at terminal 450 through a straight path when an obstacle is absent between gNB/RSU-A 400A and the terminal 450 or arrive at terminal 450 through a multipath when the obstacle is present between the gNB/RSU-A 400A and terminal 450. For example, when the first reference signal arrives at the terminal 450 through propagation during a time TAR , the reference signal received at terminal 450 may be represented in Equation 19. The terminal 450 may further decompose or demodulate the received signal sample string by FFT and can separate each signal sample from its respective nodes into subcarrier vectors as represented in Equation 19.

$${𝕐}_{ar} = N \cdot [ \begin{matrix}{P}_{AR} ( {ω}_{c} + {ω}_{1} ) {e}^{j ( {ω}_{c} + {ω}_{1} ) ( {ψ}_{R} - {ψ}_{A} - {τ}_{AR} )} \\ {P}_{AR} ( {ω}_{c} + {ω}_{2} ) {e}^{j ( {ω}_{c} + {ω}_{2} ) ( {ψ}_{R} - {ψ}_{A} - {τ}_{AR} )} \\ ⋮ \\ {P}_{AR} ( {ω}_{c} + {ω}_{m} ) {e}^{j ( {ω}_{c} + {ω}_{m} ) ( {ψ}_{R} - {ψ}_{A} - {τ}_{AR} )}\end{matrix} ] + {σ}_{A} \qquad [ Equation 19 ]$$

$${𝕐}_{br} = N \cdot [ \begin{matrix}{P}_{BR} ( {ω}_{c} + {ω}_{1} ) {e}^{j ( {ω}_{c} + {ω}_{1} ) ( {ψ}_{R} - {ψ}_{B} - {τ}_{BR} )} \\ {P}_{BR} ( {ω}_{c} + {ω}_{2} ) {e}^{j ( {ω}_{c} + {ω}_{2} ) ( {ψ}_{R} - {ψ}_{B} - {τ}_{BR} )} \\ ⋮ \\ {P}_{BR} ( {ω}_{c} + {ω}_{m} ) {e}^{j ( {ω}_{c} + {ω}_{m} ) ( {ψ}_{R} - {ψ}_{B} - {τ}_{BR} )}\end{matrix} ] + {σ}_{B}$$

$${𝕐}_{cr} = N \cdot [ \begin{matrix}{P}_{CR} ( {ω}_{c} + {ω}_{1} ) {e}^{j ( {ω}_{c} + {ω}_{1} ) ( {ψ}_{R} - {ψ}_{C} - {τ}_{CR} )} \\ {P}_{CR} ( {ω}_{c} + {ω}_{2} ) {e}^{j ( {ω}_{c} + {ω}_{2} ) ( {ψ}_{R} - {ψ}_{C} - {τ}_{CR} )} \\ ⋮ \\ {P}_{CR} ( {ω}_{c} + {ω}_{m} ) {e}^{j ( {ω}_{c} + {ω}_{m} ) ( {ψ}_{R} - {ψ}_{C} - {τ}_{CR} )}\end{matrix} ] + {σ}_{C}$$

In Equation 19, [symbol] ₐᵣ is the subcarrier phase vector of gNB/RSU-A 400A decomposed by FFT in the terminal 450. τ_{AR} in the phase vector represents the first path delay of the channel between gNB/RSU-A 400A and the terminal 450. P_{AR}(ω_{c}+ωₖ) denotes the relative delay values based on the frequencies of the carriers and subcarriers of the remaining paths except for the first channel path, τ_{AR}. Furthermore, ψ_{R} may represent the local time error of the terminal 450 while ψ_{A} may denote the local time error of gNB/RSU-A 400A.

Likewise, [symbol] _{br} denotes a subcarrier phase vector of gNB/RSU-B 400B obtained by FFT decomposition at the terminal 450. τ_{BR} is the delay of the first path of the channel between gNB/RSU-B 400B and the terminal 450, and P_{BR}(ω_{c}+ωₖ) represents the relative delay values of the remaining paths except for the first channel path τ_{BR}· 4_{R} is the local time error of the terminal 450 and ψ_{B} represents the local time error of gNB/RSU-B 400B. Likewise, [symbol] _{cr} represents a subcarrier phase vector of gNB/RSU-C 400C decomposed by FFT in the terminal 450. The phase difference vector can be obtained through a conjugate operation between subcarrier vectors as seen in Equation 20.

$${𝕐}_{a r} {𝕐}_{b r}^{*} = N [ \begin{matrix}{P}_{A R} ( {ω}_{c} + {ω}_{1} ) {e}^{j ( {ω}_{c} + {ω}_{1} ) ( {ψ}_{R} ‐ {ψ}_{A} ‐ {τ}_{A R} )} \\ {P}_{A R} ( {ω}_{c} + {ω}_{2} ) {e}^{j ( {ω}_{c} + {ω}_{2} ) ( {ψ}_{R} ‐ {ψ}_{A} ‐ {τ}_{A R} )} \\ ⋮ \\ {P}_{A R} ( {ω}_{c} + {ω}_{m} ) {e}^{j ( {ω}_{c} + {ω}_{m} ) ( {ψ}_{R} ‐ {ψ}_{A} ‐ {τ}_{A R} )}\end{matrix} ] ⊙ N \cdot [ \begin{matrix}{P}_{B R}^{*} ( {ω}_{c} + {ω}_{1} ) {e}^{‐ j ( {ω}_{c} + {ω}_{1} ) ( {ψ}_{R} ‐ {ψ}_{B} ‐ {τ}_{B R} )} \\ {P}_{B R}^{*} ( {ω}_{c} + {ω}_{2} ) {e}^{- j ( {ω}_{c} + {ω}_{2} ) ( {ψ}_{R} ‐ {ψ}_{B} ‐ {τ}_{B R} )} \\ ⋮ \\ {P}_{B R}^{*} ( {ω}_{c} + {ω}_{m} ) {e}^{‐ j ( {ω}_{c} + {ω}_{m} ) ( {ψ}_{R} ‐ {ψ}_{B} ‐ {τ}_{B R} )}\end{matrix} ] \qquad [ Equation 20 ]$$

$$∴ {𝕐}_{a r} {𝕐}_{b r}^{*} = {N}^{2} [ \begin{matrix}{P}_{A R} ( {ω}_{c} + {ω}_{1} ) {P}_{B R}^{*} ( {ω}_{c} + {ω}_{1} ) {e}^{i ( {ω}_{c} + {ω}_{1} ) ( {ψ}_{B} ‐ {ψ}_{A} + {τ}_{B R} ‐ {τ}_{A R} )} \\ {P}_{A R} ( {ω}_{c} + {ω}_{2} ) {P}_{B R}^{*} ( {ω}_{c} + {ω}_{2} ) {e}^{i ( {ω}_{c} + {ω}_{2} ) ( {ψ}_{B} ‐ {ψ}_{A} + {τ}_{B R} ‐ {τ}_{A R} )} \\ ⋮ \\ {P}_{A R} ( {ω}_{c} + {ω}_{m} ) {P}_{B R}^{*} ( {ω}_{c} + {ω}_{m} ) {e}^{i ( {ω}_{c} + {ω}_{m} ) ( {ψ}_{B} ‐ {ψ}_{A} + {τ}_{B R} ‐ {τ}_{A R} )}\end{matrix} ]$$

$$∴ {𝕐}_{a r} {𝕐}_{c r}^{*} = {N}^{2} [ \begin{matrix}{P}_{A R} ( {ω}_{c} + {ω}_{1} ) {P}_{C R}^{*} ( {ω}_{c} + {ω}_{1} ) {e}^{i ( {ω}_{c} + {ω}_{1} ) ( {ψ}_{C} ‐ {ψ}_{A} + {τ}_{C R} ‐ {τ}_{A R} )} \\ {P}_{A R} ( {ω}_{c} + {ω}_{2} ) {P}_{C R}^{*} ( {ω}_{c} + {ω}_{2} ) {e}^{i ( {ω}_{c} + {ω}_{2} ) ( {ψ}_{C} ‐ {ψ}_{A} + {τ}_{C R} ‐ {τ}_{A R} )} \\ ⋮ \\ {P}_{A R} ( {ω}_{c} + {ω}_{m} ) {P}_{CR}^{*} ( {ω}_{c} + {ω}_{m} ) {e}^{i ( {ω}_{c} + {ω}_{m} ) ( {ψ}_{C} ‐ {ψ}_{A} + {τ}_{C R} ‐ {τ}_{A R} )}\end{matrix} ]$$

In Equation 20, [symbol] ₐᵣ [symbol] *_{br} is the element-wise conjugate multiplication of the two subcarrier phase vectors [symbol] ₐᵣ and [symbol] _{br}. In the complex exponential value of [symbol] ₐᵣ [symbol] *_{br}, ψ_{B}−ψ_{A} is an initial time error caused by the local time between gNB/RSU-A 400A and gNB/RSU-B 400B. Since the terminal 450 cannot determine this value, the carrier phase difference value or phase difference information cannot be uniquely determined. Similarly, ψ_{C}−ψ_{A} is included in the complex exponential value of [symbol] ₐᵣ [symbol] *_{CR}. Unless gNB/RSU-A 400A and gNB/RSU-C 400C are synchronized, the carrier phase difference value or phase difference information cannot be uniquely determined.

In order to solve this problem of unknown carrier phase difference values, gNB/RSU-A 400A may act and be selected as a Server Node. The neighboring Nodes, gNB/RSU-B 400B and gNB/RSU-C 400C, may act as Client Nodes to help synchronize the phase of the PRS reference signal. In general, the Client Nodes will not be capable of transmitting signals without receiving a request from the Server Node. To this end, Server gNB/RSU-A 400A periodically broadcasts a PRS reference signal. This PRS signal reaches the neighboring Client gNB/RSU-B 400B and Client gNB/RSU-C 400C through a multipath channel, which is shown in the processes of Equation 3 to Equation 8. Client gNB/RSU-B 400B and Client gNB/RSU-C 400C perform FFT decomposition of the received PRS reference signal. The PRS subcarrier phase vector of can be represented by Equation 21.

$${b a}_{} = N \cdot [ \begin{matrix}{P}_{B A} ( {ω}_{c} + {ω}_{1} ) {e}^{j ( {ω}_{c} + {ω}_{1} ) ( {ψ}_{B} - {ψ}_{A} - {τ}_{B A} )} \\ {P}_{B A} ( {ω}_{c} + {ω}_{2} ) {e}^{j ( {ω}_{c} + {ω}_{2} ) ( {ψ}_{B} - {ψ}_{A} - {τ}_{B A} )} \\ ⋮ \\ {P}_{B A} ( {ω}_{c} + {ω}_{m} ) {e}^{j ( {ω}_{c} + {ω}_{m} ) ( {ψ}_{B} - {ψ}_{A} - {τ}_{B A} )}\end{matrix} ] + {σ}_{B} \qquad [ Equation 21 ]$$

In Equation 21, P_{BA}(ω_{c}+ωₖ) is the relative delay values of the remaining paths except for the first channel path delay between Server gNB/RSU-A 400A and Client gNB/RSU-B 400B, τ_{BA}. It is expressed as a complex exponential sum. ψ_{B} is the local time error of Client gNB/RSU-B 400B, ψ_{A} represents the time error of Server gNB/RSU-A 400A. When Equation 10 is applied to Equation 21, sum of all complex exponentials of the vector elements [symbol] _{ba} may be expressed using an arg (angle) sum function as represented in Equation 22.

$$arg ( sum ( {b a}_{} ) ) ≅ arg ( {e}^{j ( {ω}_{c} + {ω}_{Δ} ) ( {ψ}_{B} - {ψ}_{A} - {τ}_{B A} )} ) = ( {ω}_{c} + {ω}_{Δ} ) ( {ψ}_{B} - {ψ}_{A} - {τ}_{B A} ) - 2 π \qquad [ Equation 22 ]$$

In Equation 22, ω_{Δ} represents the center frequency of the subcarrier set 1 to subcarrier set m (first to mth components or first to mth subcarriers). ψ_{B}−ψ_{A} is the local time error of Server gNB/RSU-A 400A and Client gNB/RSU-B 400B, τ_{BA} is the first path channel delay between Server gNB/RSU-A 400A and Client gNB/RSU-B 400B, [symbol] is an unknown integer number of the carrier phase.

If the positions of Server gNB/RSU-A 400A and Client gNB/RSU-B 400B, Client gNB/RSU-C 400C, are fixed in stationary scenario, therefore, it is assumed that the paths between the two nodes are unchanged. This means that the delays τ_{BA} can be known or determined in advance. By modifying Equation 22 with reference to Equation 16, the unknown integer [symbol] of Equation 23 and transmitter/receiver time error ε_{BA} can be obtained.

$${ε}_{BA} = {ψ}_{B} - {ψ}_{A} = \frac{arg ( sum ( {ba}_{} ) ) + 2 π}{{ω}_{c} + ωΔ} + {τ}_{BA} \qquad [ Equation 23 ]$$

$$= round ( ( {ω}_{c} + {ω}_{Δ} ) {τ}_{BA} / 2 π )$$

In Equation 23, ψ_{B}−ψ_{A} represents the initial local time error of Server gNB/RSU-A 400A and Client gNB/RSU-B 400B. Client gNB/RSU-B 400B may rotate the phase of its own PRS reference signal to synchronize with the Server gNB/RSU-A 400A PRS reference signal using the time error, ε_{BA}, calculated by applying Equation 23. Client gNB/RSU-B 400B may then construct or create a synch-vector of length m using ε_{BA} as shown in Equation 24. Applying the synch-vector to the PRS reference signal will help generate a synchronized positioning reference signal.

$${synchvect}_{B A} = {[ \begin{matrix}{e}^{j ( {ω}_{c} + {ω}_{1} ) {ε}_{BA}} \\ {e}^{j ( {ω}_{c} + {ω}_{2} ) {ε}_{BA}} \\ ⋮ \\ {e}^{j ( {ω}_{c} + {ω}_{m} ) {ε}_{BA}}\end{matrix} ]}^{T} = {[ \begin{matrix}{e}^{j ( {ω}_{c} + {ω}_{1} ) ( {ψ}_{B} - {ψ}_{A} )} \\ {e}^{j ( {ω}_{c} + {ω}_{2} ) ( {ψ}_{B} - {ψ}_{A} )} \\ ⋮ \\ {e}^{j ( {ω}_{c} + {ω}_{m} ) ( {ψ}_{B} - {ψ}_{A} )}\end{matrix} ]}^{T} \qquad [ Equation 24 ]$$

An angular frequency of an element constituting the m-length synch-vector is the sum of the carrier frequency and the subcarrier frequency of the PRS reference signal (ω_{c}+ω_{q}). B₁, B₂, . . . Bₘ is the initial complex coefficient for each subcarrier. The original PRS reference signal phase vector may be rotated by the amount of synch-vector phase. Client gNB/RSU-B 400B may transmit PRSR periodically to terminal 450.

$$P R {S}_{B} ( t ) = {synchvect}_{B A} \cdot [ \begin{matrix}{B}_{1} {e}^{j {ω}_{1} ( t - {ψ}_{B} )} \\ {B}_{2} {e}^{j {ω}_{2} ( t - {ψ}_{B} )} \\ ⋮ \\ {B}_{m} {e}^{j {ω}_{3} ( t - {ψ}_{B} )}\end{matrix} ] = {[ \begin{matrix}{e}^{j ( {ω}_{c} + {ω}_{1} ) ( {ψ}_{B} - {ψ}_{A} )} \\ {e}^{j ( {ω}_{c} + {ω}_{2} ) ( {ψ}_{B} - {ψ}_{A} )} \\ ⋮ \\ {e}^{j ( {ω}_{c} + {ω}_{m} ) ( {ψ}_{B} - {ψ}_{A} )}\end{matrix} ]}^{T} \cdot [ \begin{matrix}{B}_{1} {e}^{j {ω}_{1} ( t - {ψ}_{B} )} \\ {B}_{2} {e}^{j {ω}_{2} ( t - {ψ}_{B} )} \\ ⋮ \\ {B}_{m} {e}^{j {ω}_{3} ( t - {ψ}_{B} )}\end{matrix} ] = {\sum }_{q = 1}^{m} {B}_{q} {e}^{j ( {ω}_{q} ( t - {ψ}_{A} ) + {ω}_{c} ( {ψ}_{B} - {ψ}_{A} ) )} \qquad [ Equation 25 ]$$

The passband signal regarding Client gNB/RSU-B 400B may be obtained by multiplying the sample string by the carrier frequency ω_{c}. This passband signal is expressed in Equation 26.

$$P R {S}_{Bpass} ( t ) = {e}^{j {ω}_{c} ( t - {ψ}_{B} )} \cdot {\sum }_{q = 1}^{m} {B}_{q} {e}^{j ( {ω}_{q} ( t - {ψ}_{A} ) + {ω}_{c} ( {ψ}_{B} - {ψ}_{A} ) )} \qquad [ Equation 26 ]$$

$$∴ {PRS}_{Bpass} ( t ) = {\sum }_{q = 1}^{m} {B}_{q} {e}^{j ( {ω}_{c} + {ω}_{q} ) ( t - {ψ}_{A} )}$$

Note that the complex exponential part in Equation 26 becomes (t−ψ_{A}). As a result, both the local time of the passband signal PRS_{Apass}(t) of Server gNB/RSU-A 400A and the local time of the passband signal PRS_{Bpass}(t) of Client gNB/RSU-B 400B coincide with (t−ψ_{A}). The PRS_{Apass}(t) signal and the PRS_{Bpass}(t) signal passes through each channel and reaches the terminal 450. The FFT decomposed subcarrier phase vector is expressed by Equation 27.

$${a r}_{} = N \cdot [ \begin{matrix}{P}_{A R} ( {ω}_{c} + {ω}_{1} ) {e}^{j ( {ω}_{c} + {ω}_{1} ) ( {ψ}_{R} - {ψ}_{A} - {τ}_{A R} )} \\ {P}_{A R} ( {ω}_{c} + {ω}_{2} ) {e}^{j ( {ω}_{c} + {ω}_{2} ) ( {ψ}_{R} - {ψ}_{A} - {τ}_{A R} )} \\ ⋮ \\ {P}_{A R} ( {ω}_{c} + {ω}_{m} ) {e}^{j ( {ω}_{c} + {ω}_{m} ) ( {ψ}_{R} - {ψ}_{A} - {τ}_{A R} )}\end{matrix} ] + {σ}_{A} \qquad [ Equation 27 ]$$

$${b r}_{} = N \cdot [ \begin{matrix}{P}_{B R} ( {ω}_{c} + {ω}_{1} ) {e}^{j ( {ω}_{c} + {ω}_{1} ) ( {ψ}_{R} - {ψ}_{A} - {τ}_{B R} )} \\ {P}_{B R} ( {ω}_{c} + {ω}_{2} ) {e}^{j ( {ω}_{c} + {ω}_{2} ) ( {ψ}_{R} - {ψ}_{A} - {τ}_{B R} )} \\ ⋮ \\ {P}_{B R} ( {ω}_{c} + {ω}_{m} ) {e}^{j ( {ω}_{c} + {ω}_{m} ) ( {ψ}_{R} - {ψ}_{A} - {τ}_{B R} )}\end{matrix} ] + {σ}_{B}$$

In Equation 27, [symbol] ₐᵣ is the subcarrier phase vector of Server gNB/RSU-A 400A and [symbol] _{br} is the subcarrier phase vector of Client gNB/RSU-B 400B decomposed by FFT in the terminal 450. The phase difference vector can be obtained by applying the conjugate operation between subcarrier phase vectors of Server gNB/RSU-A 400A and Client gNB/RSU-B 400B.

$${a r}_{} {b r}_{*}^{} = N \cdot [ \begin{matrix}{P}_{A R} ( {ω}_{c} + {ω}_{1} ) {e}^{j ( {ω}_{c} + {ω}_{1} ) ( {ψ}_{R} - {ψ}_{A} - {τ}_{A R} )} \\ {P}_{A R} ( {ω}_{c} + {ω}_{2} ) {e}^{j ( {ω}_{c} + {ω}_{2} ) ( {ψ}_{R} - {ψ}_{A} - {τ}_{A R} )} \\ ⋮ \\ {P}_{A R} ( {ω}_{c} + {ω}_{m} ) {e}^{j ( {ω}_{c} + {ω}_{m} ) ( {ψ}_{R} - {ψ}_{A} - {τ}_{A R} )}\end{matrix} ] ⊙ N \cdot [ \text{} \begin{matrix}{P}_{B R}^{*} ( {ω}_{c} + {ω}_{1} ) {e}^{‐ j ( {ω}_{c} + {ω}_{1} ) ( {ψ}_{R} - {ψ}_{A} - {τ}_{B R} )} \\ {P}_{B R}^{*} ( {ω}_{c} + {ω}_{2} ) {e}^{- j ( {ω}_{c} + {ω}_{2} ) ( {ψ}_{R} - {ψ}_{A} - {τ}_{B R} )} \\ ⋮ \\ {P}_{B R}^{*} ( {ω}_{c} + {ω}_{m} ) {e}^{‐ j ( {ω}_{c} + {ω}_{m} ) ( {ψ}_{R} - {ψ}_{A} - {τ}_{B R} )}\end{matrix} ] \qquad [ Equation 28 ]$$

$$∴ {a r}_{} {b r}_{*}^{} = {N}^{2} \cdot [ \begin{matrix}{P}_{A R} ( {ω}_{c} + {ω}_{1} ) {P}_{B R}^{*} ( {ω}_{c} + {ω}_{1} ) {e}^{i ( {ω}_{c} + {ω}_{1} ) ( {τ}_{B R} - {τ}_{A R} )} \\ {P}_{A R} ( {ω}_{c} + {ω}_{2} ) {P}_{B R}^{*} ( {ω}_{c} + {ω}_{2} ) {e}^{i ( {ω}_{c} + {ω}_{2} ) ( {τ}_{B R} - {τ}_{A R} )} \\ ⋮ \\ {P}_{A R} ( {ω}_{c} + {ω}_{m} ) {P}_{B R}^{*} ( {ω}_{c} + {ω}_{m} ) {e}^{i ( {ω}_{c} + {ω}_{m} ) ( {τ}_{B R} - {τ}_{A R} )}\end{matrix} ]$$

In Equation 28, [symbol] ₐᵣ [symbol] represents the result of the conjugate product between the elements of the two subcarrier phase vectors [symbol] ₐᵣ, [symbol] _{br}. Unlike Equation 20, initial local-time error (VB - WA) can be removed in the complex exponentials of [symbol] ₐᵣ [symbol] . This is because the error value can be canceled out in advance at the Client gNB/RSU-B 400B before it transmits a reference signal PRS_{B}. The conjugate product of the two residual paths is P_{AR}(ω_{c}+ω_{K})P*_{BR}(ω_{c}+ω_{K}). In a Rician channel with few or no obstacles on the path, the phase value is almost or approximately zero. Therefore, a carrier phase difference equation can be obtained by removing the residual path component and the local time error term and by applying the arg (angle) function as seen in Equation 29.

$$arg ( sum ( {a r}_{} {b r}_{*}^{} ) ) ≅ arg ( {e}^{j ( {ω}_{c} + {ω}_{Δ} ) ( {τ}_{B R} - {τ}_{A R} )} ) = ( {ω}_{c} + {ω}_{Δ} ) ( {τ}_{B R} - {τ}_{A R} ) - 2 π {R}_{} \qquad [ Equation 29 ]$$

In Equation 29, [symbol] is an unknown integer for the carrier phase. To solve for the unknown integer, the lower m−1 subvector and the upper m−1 subvector in the subcarrier vector [symbol] ₐᵣ [symbol] are self-conjugated in a similar way as in Equation 11. Note that the subcarrier gap frequencies of the vectors are all ω_{g}.

$${ar}_{} {br}_{*}^{} {br}_{} {ar}_{*}^{} = {N}^{2} \cdot [ \begin{matrix}{P}_{A R} ( {ω}_{c} + {ω}_{2} ) {P}_{B R}^{*} ( {ω}_{c} + {ω}_{2} ) {P}_{B R} ( {ω}_{c} + \\ {ω}_{1} ) {P}_{A R}^{*} ( {ω}_{c} + {ω}_{1} ) {e}^{j {ω}_{g} ( {τ}_{B R} - {τ}_{A R} )} \\ {P}_{A R} ( {ω}_{c} + {ω}_{3} ) {P}_{B R}^{*} ( {ω}_{c} + {ω}_{3} ) {P}_{B R} ( {ω}_{c} + \\ {ω}_{2} ) {P}_{A R}^{*} ( {ω}_{c} + {ω}_{2} ) {e}^{j {ω}_{g} ( {τ}_{B R} - {τ}_{A R} )} \\ ⋮ \\ {P}_{A R} ( {ω}_{c} + {ω}_{m} ) {P}_{B R}^{*} ( {ω}_{c} + {ω}_{m} ) {P}_{B R} ( {ω}_{c} + \\ {ω}_{m - 1} ) {P}_{A R}^{*} ( {ω}_{c} + {ω}_{m - 1} ) {e}^{j {ω}_{g} ( {τ}_{B R} - {τ}_{A R} )}\end{matrix} ] \qquad [ Equation 30 ]$$

The phase component of subcarrier gap frequency ω_{g} may be obtained by applying the arg (angle) sum function to the vectors of Equation 30.

$$arg ( sum ( {ar}_{} {br}_{*}^{} {br}_{} {ar}_{*}^{} ) ) ≅ arg ( {e}^{j {ω}_{g} ( {τ}_{B R} - {τ}_{A R} )} ) = {ω}_{g} ( {τ}_{B R} - {τ}_{A R} ) \qquad [ Equation 31 ]$$

By substituting Equation 31 into Equation 29, the unknown integer solution for [symbol] can be obtained as represented in Equation 32.

$$∴ {R}_{} = round ⌊ \frac{( {ω}_{c} + {ω}_{Δ} )}{{ω}_{g}} \cdot {ϕ}_{s} / 2 π - {ϕ}_{c} / 2 π ⌋ \qquad [ Equation 32 ]$$

$${ϕ}_{s} = arg ( sum ( {a r}_{} {b r}_{*}^{} {b r}_{} {a r}_{*}^{} ) ) ,$$

$${ϕ}_{c} = arg ( sum ( {a r}_{} {b r}_{*}^{} ) )$$

In Equation 32, ω_{g} represents the frequency gap between the subcarrier vectors of the reference signals transmitted by Server gNB/RSU-A 400A. (ω_{c}+ω_{g}) /ω_{g} represents the ratio between the carrier frequency and the sub-carrier gap frequency, ϕₛ represents the sub-carrier phase difference calculated by applying Equation 29, and ϕ_{c} represents the carrier phase difference calculated by applying Equation 31.

Finally, the carrier phase based time difference (τ_{BR}−τ_{AR}) can be calculated by applying the integer number [symbol] into Equation 29.

$${d}_{A B} = 𝕔 ( {τ}_{B R} - {τ}_{A R} ) = 𝕔 \frac{arg ( sum ( {a r}_{} {b r}_{*}^{} ) ) + 2 π {R}_{}}{( {ω}_{c} + {ω}_{Δ} )} \qquad [ Equation 33 ]$$

As a result, the terminal 450 can calculate accurate carrier phase difference or obtain carrier phase information based on the distance difference in which local time errors of node devices are removed by the PRS synchronization method. The (x,y,z) coordination of the V2X UE-B or terminal 450 can also be calculated by applying a trilateration function or the likes thereof.

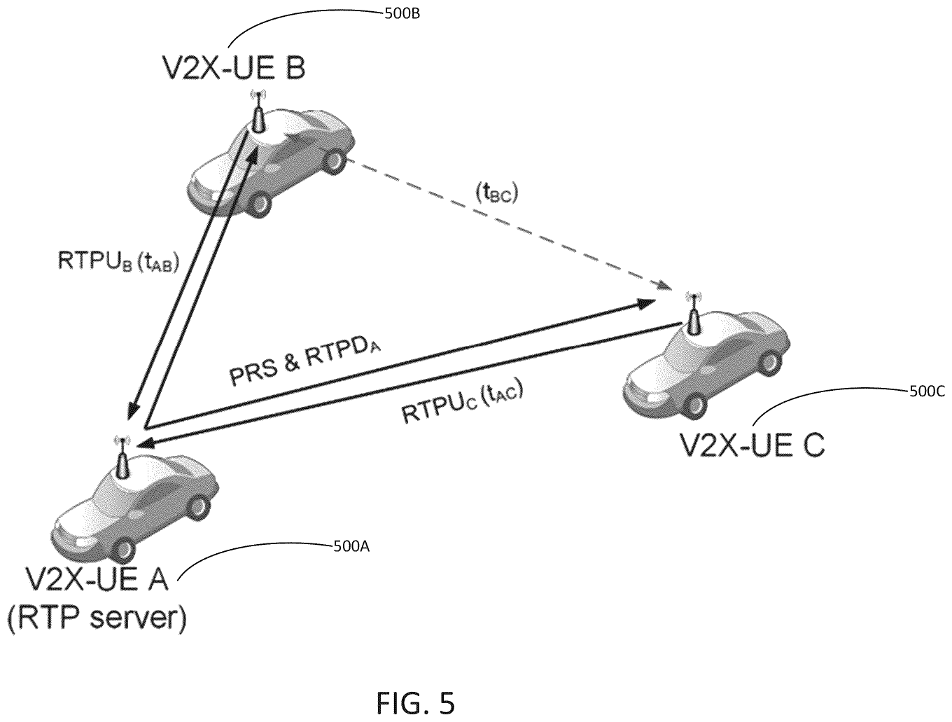

FIG. 5 is a conceptual diagram illustrating a communication system according to another exemplary embodiment. If a synch-vector is applied in the round-trip signal exchanged between two node devices, the synch-vector can also be used to synchronize the local time of two node devices or to obtain distance information between the two node devices. For example, distance and location information may be detected between vehicles while exchanging round-trip signals between moving vehicles. The V2X-UE devices of moving vehicles operate unsynchronized local clocks. There is an error related to each moving vehicle, noted as ψ_{A} for V2X-UE A 500A, ψ_{B} for V2X-UE B 500B, and ψ_{CA} for V2X-UE C 500C. This error time may be compared to absolute time, t. V2X-UE devices in vehicles periodically broadcast PRS reference signals. When the V2X-UE devices receive the PRS reference signal transmitted by another vehicle, it returns a RTPU (Return Trip Phase-Uplink) reference signal to which a synch-vector is applied. The surrounding vehicles determine delay and distance information using the phase information included in the RTPU. This process may refer to Equation 21, where the PRS subcarrier vector of V2X-UE A 500A is received and decomposed by V2X-UE B 500B. For this embodiment, V2X-UE A 500A may be selected as the RTP Server Node while V2X-UE B 500B and V2X-UE C 500C may be Client Nodes. This decomposition can be represented by Equation 34.

$${b a}_{} = N \cdot [ \begin{matrix}{P}_{B A} ( {ω}_{c} + {ω}_{1} ) {e}^{j ( {ω}_{c} + {ω}_{1} ) ( {ψ}_{B} - {ψ}_{A} - {τ}_{B A} )} \\ {P}_{B A} ( {ω}_{c} + {ω}_{2} ) {e}^{j ( {ω}_{c} + {ω}_{2} ) ( {ψ}_{B} - {ψ}_{A} - {τ}_{B A} )} \\ ⋮ \\ {P}_{B A} ( {ω}_{c} + {ω}_{m} ) {e}^{j ( {ω}_{c} + {ω}_{m} ) ( {ψ}_{B} - {ψ}_{A} - {τ}_{B A} )}\end{matrix} ] + {σ}_{B} \qquad [ Equation 34 ]$$

In Equation 34, P_{BA}(ω_{c}+ω_{K}) is the relative delay values of the remaining paths except for the first channel path delay τ_{BA} between V2X-UE A 500A and V2X-UE B 500B. ψ_{B} is the local time error of V2X-UE B 500B and ψ_{A} represents the time error of V2X-UE A 500A. The sum of all elements of the vector [symbol] _{ba} can be obtained by applying the arg (angle) sum function expression as represented in Equation 35.

$$arg ( sum ( {b a}_{} ) ) ≅ arg ( {e}^{j ( {ω}_{c} + {ω}_{Δ} ) ( {ψ}_{B} - {ψ}_{A} - {τ}_{B A} )} ) = ( {ω}_{c} + {ω}_{Δ} ) ( {ψ}_{B} - {ψ}_{A} - {τ}_{B A} ) - 2 π \qquad [ Equation 35 ]$$

In Equation 35, ω_{Δ} is the intermediate frequency of the subcarrier set 1 to subcarrier set m (first to mth components or first to mth subcarriers). ψ_{B}−ψ_{A} is the local time error of V2X-UE A 500A and V2X-UE B 500B, τ_{BA} is the first path channel delay between V2X-UE A 500A and V2X-UE B 500B, [symbol] is the unknown integer number of the carrier phase. Equation 36 is the sum of path delay and transmission/reception time error (ψ_{B}−ψ_{A}−τ_{BA}).

$${δ}_{B A} = {ψ}_{B} - {ψ}_{A} - {τ}_{B A} = \frac{arg ( sum ( {b a}_{} ) ) + 2 π}{{ω}_{c} + {ω}_{Δ}} \qquad [ Equation 36 ]$$

A synch-vector with a size of 2 m can be created using synch-vector δ_{BA} of Equation 36.

$$[ Equation 37 ]$$

$${synchvect}_{B A} = {[ \begin{matrix}1 \\ 1 \\ ⋮ \\ 1 \\ {e}^{j ( {ω}_{c} + {ω}_{m + 1} ) {δ}_{BA}} \\ {e}^{j ( {ω}_{c} + {ω}_{m + 2} ) {δ}_{BA}} \\ ⋮ \\ {e}^{j ( {ω}_{c} + {ω}_{2 m} ) {δ}_{BA}}\end{matrix} ]}^{T} = {[ \begin{matrix}1 \\ 1 \\ ⋮ \\ 1 \\ {e}^{j ( {ω}_{c} + {ω}_{m + 1} ) ( {ψ}_{B} - {ψ}_{A} - {τ}_{BA} )} \\ {e}^{j ( {ω}_{c} + {ω}_{m + 2} ) ( {ψ}_{B} - {ψ}_{A} - {τ}_{BA} )} \\ ⋮ \\ {e}^{j ( {ω}_{c} + {ω}_{2 m} ) ( {ψ}_{B} - {ψ}_{A} - {τ}_{BA} )}\end{matrix} ]}^{T}$$

In the synch-vector of Equation 37, the upper 1 . . . m subvector elements are all 1. The lower (m+1) . . . 2 m subvector are complex exponents consisting of the value δ_{BA}. Using the synch-vector, the RTPU_{B}(t) reference signal can be composed by dot product (i.e. inner product) of the synch-vector and the PRS reference signal of the size 2 m, as seen in Equation 38. The client-specific synchronized positioning reference signal may include 2 m subcarriers and time variables of first to mth subcarriers depending on a local time of each of the client nodes, wherein the time variables of the first to mth subcarriers do not depend on a local time of the server node.

$${RTPU}_{B} ( t ) = {synchvect}_{B A} \cdot [ \begin{matrix}{B}_{1} {e}^{j {ω}_{1} ( t - {ψ}_{B} )} \\ {B}_{2} {e}^{j {ω}_{2} ( t - {ψ}_{B} )} \\ ⋮ \\ {B}_{m} {e}^{j {ω}_{m} ( t - {ψ}_{B} )} \\ {B}_{m + 1} {e}^{j {ω}_{m + 1} ( t - {ψ}_{B} )} \\ {B}_{m + 2} {e}^{j {ω}_{m + 2} ( t - {ψ}_{B} )} \\ ⋮ \\ {B}_{2 m} {e}^{j {ω}_{2 m} ( t - {ψ}_{B} )}\end{matrix} ] = [ \begin{matrix}1 \\ 1 \\ ⋮ \\ 1 \\ {e}^{j ( {ω}_{c} + {ω}_{m + 1} ) ( {ψ}_{B} - {ψ}_{A} - {τ}_{BA} )} \\ {e}^{j ( {ω}_{c} + {ω}_{m + 2} ) ( {ψ}_{B} - {ψ}_{A} - {τ}_{BA} )} \\ ⋮ \\ {e}^{j ( {ω}_{c} + {ω}_{2 m} ) ( {ψ}_{B} - {ψ}_{A} - {τ}_{BA} )}\end{matrix} ] \cdot [ \begin{matrix}{B}_{1} {e}^{j {ω}_{1} ( t - {ψ}_{B} )} \\ {B}_{2} {e}^{j {ω}_{2} ( t - {ψ}_{B} )} \\ ⋮ \\ {B}_{m} {e}^{j {ω}_{m} ( t - {ψ}_{B} )} \\ {B}_{m + 1} {e}^{j {ω}_{m + 1} ( t - {ψ}_{B} )} \\ {B}_{m + 2} {e}^{j {ω}_{m + 2} ( t - {ψ}_{B} )} \\ ⋮ \\ {B}_{2 m} {e}^{j {ω}_{2 m} ( t - {ψ}_{B} )}\end{matrix} ] = {\sum }_{q = 1}^{m} {B}_{q} {e}^{j {ω}_{q} ( t - {ψ}_{B} )} + {\sum }_{q = m + 1}^{2 m} {B}_{q} {e}^{j ( {ω}_{q} ( t - {τ}_{B A} - {ψ}_{A} ) + {ω}_{c} ( {ψ}_{B - {ψ}_{A} - {τ}_{B A} ) )}} \qquad [ Equation 38 ]$$

In Equation 38, the RTPU_{B}(t) reference signal returned by V2X-UE B 500B is characterized by containing the PRS reference signal part of V2X-UE B 500B in the upper 1 . . . m subvector and path delay information of the PRS sent by V2X-UE A 500A in the lower (m+1) . . . 2 m subvector portion. The passband signal is obtained by multiplying the carrier frequency ω_{c} (i.e., up-conversion) by the RTPU_{B}(t) signal samples.

$${RTPU}_{Bpass} ( t ) = {e}^{j {ω}_{c} ( t - {ψ}_{B} )} \cdot {\sum }_{q = 1}^{m} {B}_{q} {e}^{j {ω}_{q} ( t - {ψ}_{B} )} + {e}^{j {ω}_{c} ( t - {ψ}_{B} )} \cdot {\sum }_{q = m + 1}^{2 m} {B}_{q} {e}^{j ( {ω}_{q} ( t - {ψ}_{A} - {τ}_{B A} ) + {ω}_{c} ( {ψ}_{B} - {ψ}_{A} - {τ}_{B A} ) )} = {\sum }_{q = 1}^{m} {B}_{q} {e}^{j ( {ω}_{c} + {ω}_{q} ) ( t - {ψ}_{B} )} + {\sum }_{q = m + 1}^{2 m} {B}_{q} {e}^{j ( {ω}_{c} + {ω}_{q} ) ( t - {ψ}_{A} - {τ}_{B A} )} \qquad [ Equation 39 ]$$

Assuming the up-down channel between the two vehicles, V2X-UE A 500A and V2X-UE B 500B, is the same (i.e. reciprocal), the RTPU_{B}(t) signal arriving at the V2X-UE A 500A may be represented by Equation 40.

$${RTPU}_{Bc ℏ} ( t ) = {\sum }_{q = 1}^{m} {H}_{A} ( {ω}_{c} + {ω}_{q} ) {B}_{q} {e}^{j ( {ω}_{c} + {ω}_{q} ) ( t - {ψ}_{B} )} + {\sum }_{q = m + 1}^{2 m} {H}_{A} ( {ω}_{c} + {ω}_{q} ) {B}_{q} {e}^{j ( {ω}_{c} + {ω}_{q} ) ( t - {ψ}_{A} - {τ}_{B A} )} = {\sum }_{q = 1}^{m} {P}_{A B} ( {ω}_{c} + {ω}_{q} ) {B}_{q} {e}^{j ( {ω}_{c} + {ω}_{q} ) ( t - {ψ}_{B} - {τ}_{B A} )} + {\sum }_{q = m + 1}^{2 m} {P}_{A B} ( {ω}_{c} + {ω}_{q} ) {B}_{q} {e}^{j ( {ω}_{c} + {ω}_{q} ) ( t - {ψ}_{A} - 2 {τ}_{B A} )} \qquad [ Equation 40 ]$$

By multiplying inverse carrier frequency ω_{c} in the receiving RF module of V2X-UE A 500A, the RTPU_{B}(t) signal is converted to a baseband signal y_{ab}(t) as represented in Equation 41.

$${y}_{ab} ( t ) = {e}^{- j {ω}_{c} ( t - {ψ}_{A} )} \cdot {RTPU}_{Bc ℏ} ( t ) = {\sum }_{q = 1}^{m} {P}_{A B} ( {ω}_{c} + {ω}_{q} ) {B}_{q} {e}^{j ( {ω}_{c} ( {ψ}_{A} - {ψ}_{B} - {τ}_{B A} ) + {ω}_{q} ( t - {ψ}_{B} - {τ}_{B A} ) )} + {\sum }_{q = m + 1}^{2 m} {P}_{A B} ( {ω}_{c} + {ω}_{q} ) {B}_{q} {e}^{j ( - 2 {τ}_{B A} {ω}_{c} + {ω}_{q} ( t - {ψ}_{A} - 2 {τ}_{B A} ) )} \qquad [ Equation 41 ]$$

The frequency domain subcarrier vector [symbol] _{AB} can be obtained by collecting N number of y_{ab}(t) signal samples and applying FFT as represented in Equation 42. Equation 42 is the initial complex coefficient given to each subcarrier of the RTPU_{B}(t) reference signal. If the coefficients B₁, B₂, . . . B₂ₘ in Equation 42 is known by V2X-UE A 500A in advance, it can be removed. The [symbol] _{AB} vector is divided into upper 1 . . . m subvector and lower (m+1) . . . 2 m subvector.

$${A B}_{} = N \cdot [ \begin{matrix}{P}_{A B} ( {ω}_{c} + {ω}_{1} ) {B}_{1} {e}^{j ( {ω}_{c} + {ω}_{1} ) ( {ψ}_{A} - {ψ}_{B} - {τ}_{B A} )} \\ {P}_{A B} ( {ω}_{c} + {ω}_{2} ) {B}_{2} {e}^{j ( {ω}_{c} + {ω}_{2} ) ( {ψ}_{A} - {ψ}_{B} - {τ}_{B A} )} \\ ⋮ \\ {P}_{A B} ( {ω}_{c} + {ω}_{m} ) {B}_{m} {e}^{j ( {ω}_{c} + {ω}_{m} ) ( {ψ}_{A} - {ψ}_{B} - {τ}_{B A} )} \\ {P}_{A B} ( {ω}_{c} + {ω}_{m + 1} ) {B}_{m + 1} {e}^{- j ( {ω}_{c} + {ω}_{m + 1} ) 2 {τ}_{B A} )} \\ {P}_{A B} ( {ω}_{c} + {ω}_{m + 2} ) {B}_{m + 2} {e}^{- j ( {ω}_{c} + {ω}_{m + 2} ) 2 {τ}_{B A} )} \\ ⋮ \\ {P}_{A B} ( {ω}_{c} + {ω}_{2 m} ) {B}_{2 m} {e}^{- j ( {ω}_{c} + {ω}_{2 m} ) 2 {τ}_{B A} )}\end{matrix} ] + {σ}_{a b} \qquad [ Equation 42 ]$$

Applying the argument (angle) sum function to each of these subvectors yields two carrier phase information as represented in Equation 43 and Equation 44.

$$\begin{matrix}{a b 1}_{} = [ \begin{matrix}{P}_{A B} ( {ω}_{c} + {ω}_{1} ) {e}^{j ( {ω}_{c} + {ω}_{1} ) ( {ψ}_{A} - {ψ}_{B} - {τ}_{B A} )} \\ {P}_{A B} ( {ω}_{c} + {ω}_{2} ) {e}^{j ( {ω}_{c} + {ω}_{2} ) ( {ψ}_{A} - {ψ}_{B} - {τ}_{B A} )} \\ ⋮ \\ {P}_{A B} ( {ω}_{c} + {ω}_{m} ) {e}^{j ( {ω}_{c} + {ω}_{m} ) ( {ψ}_{A} - {ψ}_{B} - {τ}_{B A} )}\end{matrix} ] \\ arg ( sum ( {a b 1}_{} ) ) ≅ arg ( {e}^{j ( {ω}_{c} + {ω}_{Δ} ) ( {ψ}_{A} - {ψ}_{B} - {τ}_{B A} )} ) = ( {ω}_{c} + {ω}_{Δ} ) ( {ψ}_{A} - {ψ}_{B} - {τ}_{B A} ) - 2 π\end{matrix} \qquad [ Equation 43 ]$$

The subvector [symbol] _{ab1} of Equation 43 is in effect the same as the subcarrier vector obtained by FFT decomposition of the PRS reference signal received from V2X-UE B 500B. Therefore, using the RTPU reference signal, it may also serve as a PRS signal.

$$\begin{matrix}{ab 2}_{} = [ \begin{matrix}{P}_{A B} ( {ω}_{c} + {ω}_{m + 1} ) {e}^{- j ( {ω}_{c} + {ω}_{m + 1} ) 2 {τ}_{B A}} \\ {P}_{A B} ( {ω}_{c} + {ω}_{m + 2} ) {e}^{- j ( {ω}_{c} + {ω}_{m + 2} ) 2 {τ}_{B A}} \\ ⋮ \\ {P}_{A B} ( {ω}_{c} + {ω}_{2 m} ) {e}^{- j ( {ω}_{c} + {ω}_{2 m} ) 2 {τ}_{B A}}\end{matrix} ] \\ ∴ arg ( sum ( {ab 2}_{} ) ) ≅ arg ( {e}^{- j2 {τ}_{B A} ( {ω}_{c} + {ω}_{m + Δ} )} ) = - 2 {τ}_{B A} ( {ω}_{c} + {ω}_{m + Δ} ) - 2 π\end{matrix} \qquad [ Equation 44 ]$$

The subvector [symbol] _{ab2} of Equation 44 contains the information of twice of the path delay 2TBA between the V2X-UE A 500A and V2X-UE B 500B. Note that the offset of the local time error (ψ_{A}−ψ_{B}) of the two Nodes V2X-UE A 500A and V2X-UE B 500B are canceled out during the return operation of the RTP signal. ω_{Δ} is the intermediate frequency of the subcarrier, and [symbol] and [symbol] is the unknown integers of the carrier phases. To obtain the values of the unknown integers in the carrier phases, Equation 11 may be applied to Equation 44. A phase difference vector and subcarrier gap frequency ω_{g} can be obtained by conjugate multiplication operation between the lower m−1 subvector and upper m−1 subvector of [symbol] _{ab2}.

$${ab 2}_{} {ab 2}_{*}^{} = N \cdot [ \begin{matrix}{P}_{A B} ( {ω}_{c} + {ω}_{m + 2} ) {e}^{- j ( {ω}_{c} + {ω}_{m + 2} ) 2 {τ}_{B A}} \\ {P}_{A B} ( {ω}_{c} + {ω}_{m + 3} ) {e}^{- j ( {ω}_{c} + {ω}_{m + 3} ) 2 {τ}_{B A}} \\ ⋮ \\ {P}_{A B} ( {ω}_{c} + {ω}_{2 m} ) {e}^{- j ( {ω}_{c} + {ω}_{2 m} ) 2 {τ}_{B A}}\end{matrix} ] ⊙ N \cdot [ \text{} \begin{matrix}{P}_{A B}^{*} ( {ω}_{c} + {ω}_{m + 1} ) {e}^{j ( {ω}_{c} + {ω}_{m + 1} ) 2 {τ}_{B A}} \\ {P}_{A B}^{*} ( {ω}_{c} + {ω}_{m + 2} ) {e}^{j ( {ω}_{c} + {ω}_{m + 2} ) 2 {τ}_{B A}} \\ ⋮ \\ {P}_{A B}^{*} ( {ω}_{c} + {ω}_{2 m - 1} ) {e}^{j ( {ω}_{c} + {ω}_{2 m - 1} ) 2 {τ}_{B A}}\end{matrix} ] = {N}^{2} \cdot [ \begin{matrix}{P}_{A B} ( {ω}_{c} + {ω}_{m + 1} ) {P}_{A B}^{*} ( {ω}_{c} + {ω}_{m + 2} ) {e}^{j {ω}_{g} 2 {τ}_{B A}} \\ {P}_{A B} ( {ω}_{c} + {ω}_{m + 2} ) {P}_{A B}^{*} ( {ω}_{c} + {ω}_{m + 3} ) {e}^{j {ω}_{g} 2 {τ}_{B A}} \\ ⋮ \\ {P}_{A B} ( {ω}_{c} + {ω}_{2 m - 1} ) {P}_{A B}^{*} ( {ω}_{c} + {ω}_{2 m} ) {e}^{j {ω}_{g} 2 {τ}_{B A}}\end{matrix} ] \qquad [ Equation 45 ]$$

Unlike the stationary scenario described in paragraphs [0069 ] and [0098] of the present disclosure, the V2X UEs do not know the first path delay τ_{BA} in advance. However, in Equation 45, if the subcarrier gap frequency ω_{g} is sufficiently small and the distance between the transmitter and receiver is less than half a wavelength, the first path delay τ_{BA} can be known without unspecified ambiguity as shown in Equation 46.

$$\begin{matrix}arg ( sum ( {ab 2}_{} {ab 2}_{*}^{} ) ) ≅ - 2 {τ}_{B A} {ω}_{g} \\ ∴ {τ}_{B A} = - arg ( sum ( {a b 2}_{} {a b 2}_{*}^{} ) ) / 2 {ω}_{g}\end{matrix} \qquad [ Equation 46 ]$$

Path delay τ_{BA} is in fact not sufficiently accurate because the gap frequency ω_{g} is coarse and gap frequency is greatly affected by noise. However, the path delay is sufficient to estimate the unknown integer value [symbol] in the carrier phase equation of Equation 44. Given this, Equation 47 may represent the integer number resolution function of the carrier frequency (ω_{c}+ω_{Δ}).

$$\begin{matrix}= round ( - {τ}_{B A} ( {ω}_{c} + {ω}_{Δ} ) / π - arg ( sum ( {a b 2}_{} ) ) / 2 π ) \\ ∴ {N}_{c 2} = round ⌊ \frac{( {ω}_{c} + {ω}_{Δ} )}{{ω}_{g}} \cdot {ϕ}_{s} / 2 π - {ϕ}_{c} / 2 π ⌋ \\ {ϕ}_{s} = arg ( sum ( {a b 2}_{} {a b 2}_{*}^{} ) ) , {ϕ}_{c} = arg ( sum ( {a b 2}_{} ) )\end{matrix} \qquad [ Equation 47 ]$$

In Equation 47, ω_{g} represents the frequency difference between the sub-carrier vectors of the reference signals used by V2X-UE A 500A and V2X-UE B 500B. (ω_{c}+ω_{g})/ϕₛ represents the ratio between the carrier frequency and the sub-carrier gap frequency, ϕₛ represents the sub-carrier phase difference calculated by applying Equation 44, and ϕ_{c} represents the carrier phase difference calculated by applying Equation 46. By applying the resolved integer number [symbol] obtained from Equation 47 to the carrier-based phase equation of Equation 44, improved accuracy of the path delay τ_{BA} can be obtained.

$$∴ {τ}_{B A} = - \frac{arg ( sum ( {a b 2}_{} ) ) + 2 π}{2 ( {ω}_{c} + {ω}_{Δ} )} \qquad [ Equation 48 ]$$

Upon receiving the RTPU_{B}(t) signal from V2X-UE B 500B, the V2X-UE A 500A may now determine the distance information between the two vehicles with high accuracy and without local timing error. This method can also be applied in both the mobile or stationary case where the location of the Node receiving the RTPU is fixed such as the gNB or RSU in FIG. 4.

The RTPU method described has a limitation that only the Node receiving the RTPU has the distance information and the sender of the RTPU does not know the information unless the receiver specifically informs it. Three-way message exchange may provide mutual information to both the transmitting Node and the receiving Node. However, a total number of message exchange between all member of Nodes may become unbearably large if the number of Nodes increases. In order to reduce the exponential growth of the message exchange between all Nodes, this invention discloses a method of restricting the signal exchange only between a chosen Node and the remainder Nodes. A Server Node, called a RTP server, is elected among a group of Nodes. For example, an RTP Server Node may be chosen either by choosing a fixed-location Node, such as a gNB/TRP or RSU device, or choosing a mobile Node according to predetermined priorities, etc.

In some embodiments, V2X-UE A 500A may be selected as an RTP Server Node. RTP Server Node or V2X-UE A 500A may receive RTPU reference signals from both neighboring V2X-UE B 500B and V2X-UE C 500C. As a result, RTP Server Node or V2X-UE A 500A has the information regarding the path delay τ_{AB} between V2X-UE A 500A and V2X-UE B 500B as well as τ_{AC}, where V2X-UE A 500A get all the information between V2X-UE A 500A and V2X-UE C 500C.

Since the V2X-UE A 500A has all the path delay information to neighbors V2X-UE B 500B and V2X-UE C 500C, V2X-UE A 500A periodically broadcasts the collected information using a RTPD (Return Path Phase—Downlink) reference signal. This reference signal may be referred to as a propagation delay broadcast signal. The present disclosure may refer a propagation delay broadcast signal sequence of each subcarrier that makes up the propagation delay broadcast signal. For example, a signal generation vector may be constructed for generating a propagation delay broadcast signal. Similar method used for RTPU signal is applied for generating the RTPD signal. Equation 49 shows the synch-vector used for composing the RTPD reference signal.

$${synchvect}_{A} = [ \begin{matrix}1 \\ 1 \\ ⋮ \\ 1 \\ {e}^{- j ( {ω}_{c} + {ω}_{m + 1} ) {τ}_{A B}} \\ {e}^{- j ( {ω}_{c} + {ω}_{m + 2} ) {τ}_{A B}} \\ ⋮ \\ {e}^{- j ( {ω}_{c} + {ω}_{2 m} ) {τ}_{A B}} \\ {e}^{- j ( {ω}_{c} + {ω}_{2 m + 1} ) {τ}_{AC}} \\ {e}^{- j ( {ω}_{c} + {ω}_{2 m + 2} ) {τ}_{AC}} \\ ⋮ \\ {e}^{- j ( {ω}_{c} + {ω}_{3 m} ) {τ}_{AC}} \\ ⋮\end{matrix} ] \qquad [ Equation 49 ]$$

The top 1 . . . m elements of the synch-vector in Equation 49 are all 1's, and the subsequent (m+1) . . . 2m position contains the path delay information of τ_{AB} in the complex exponential part of the synch-vector. For example, first to mth components of a synch-vector based on propagation delay or path delay between the server node and each of the client nodes may be set to a same constant. Following the τ_{AB} part, (2m+1) . . . 3m position contains the path delay information of τ_{AC}, and so forth. In order to broadcast k pieces (between a kth node and a first node) of path delay information in the above method, (k+1)*m length synch-vector is necessary. For example, setting km+1th to (k+1)mth components of the synch-vector based on propagation delay to complex numbers having a phase depending on a path delay time between a kth node and a first node.

V2X-UE A 500A constructs a km+1th to (k+1)mth length PRS subcarrier vector and inner products with the (k+1)mth length synch-vector of Equation 49 to produce a RTPD_{A}(Return Path Phase—Downlink) reference signal.

$${RTPD}_{A} ( t ) = {synchvect}_{A} \cdot [ \text{} \begin{matrix}{A}_{1} {e}^{j {ω}_{1} ( t - {ψ}_{A} )} \\ {A}_{1} {e}^{j {ω}_{2} ( t - {ψ}_{A} )} \\ ⋮ \\ {A}_{( k + 1 ) m} {e}^{j {ω}_{( k + 1 ) m} ( t - {ψ}_{A} )}\end{matrix} ] = [ \begin{matrix}1 \\ 1 \\ ⋮ \\ 1 \\ {e}^{- j ( {ω}_{c} + {ω}_{m + 1} ) {τ}_{A B}} \\ {e}^{- j ( {ω}_{c} + {ω}_{m + 2} ) {τ}_{A B}} \\ ⋮ \\ {e}^{- j ( {ω}_{c} + {ω}_{2 m} ) {τ}_{A B}} \\ {e}^{- j ( {ω}_{c} + {ω}_{2 m + 1} ) {τ}_{AC}} \\ {e}^{- j ( {ω}_{c} + {ω}_{2 m + 2} ) {τ}_{AC}} \\ ⋮ \\ {e}^{- j ( {ω}_{c} + {ω}_{3 m} ) {τ}_{AC}} \\ ⋮\end{matrix} ] \cdot [ \text{} \begin{matrix}{A}_{1} {e}^{j {ω}_{1} ( t - {ψ}_{A} )} \\ {A}_{1} {e}^{j {ω}_{2} ( t - {ψ}_{A} )} \\ ⋮ \\ {A}_{( k + 1 ) m} {e}^{j {ω}_{( k + 1 ) m} ( t - {ψ}_{A} )}\end{matrix} ] = {\sum }_{q = 1}^{m} {A}_{q} {e}^{j {ω}_{q} ( t - {ψ}_{A} )} + {\sum }_{q = m + 1}^{2 m} {A}_{q} {e}^{j ( {ω}_{q} ( t - {ψ}_{A} - {τ}_{AB} ) - {ω}_{c} {τ}_{AB} )} + {\sum }_{q = 2 m + 1}^{3 m} {A}_{q} {e}^{j ( {ω}_{q} ( t - {ψ}_{A} - {τ}_{AC} ) - {ω}_{c} {τ}_{AC} )} + … \qquad [ Equation 50 ]$$

The passband signal of the RTPD_{A}(t) is modulated by multiplying the baseband signal samples described in Equation 50 with the carrier frequency ω_{c}.

$${RTPD}_{A p a s s} ( t ) = {e}^{j {ω}_{c} ( 𝔱 - {ψ}_{A} )} \cdot {\sum }_{q = 1}^{m} {A}_{q} {e}^{j {ω}_{q} ( t - {ψ}_{A} )} + {e}^{j {ω}_{C} ( 𝔱 - {ψ}_{A} )} \cdot {\sum }_{q = m + 1}^{2 m} {A}_{q} {e}^{j ( {ω}_{q} ( 𝔱 - {ψ}_{A} - {τ}_{A B} ) - {ω}_{c} {τ}_{A B} )} \qquad [ Equation 51 ]$$

The RTP Server Node or V2X-UE A 500A periodically broadcasts the RTPD_{Apass}(t) signal of Equation 50 to neighboring Nodes. This signal passes through a radio channel to reach all other vehicles. For example, the RTPD_{Ach}(t)signal reaching V2X-UE B 500B through the channel between V2X-UE A 500A and V2X-UE B 500B can be expressed in Equation 52.

$${RTPD}_{Ac𝒽} ( t ) = {\sum }_{q = 1}^{m} {H}_{AB} ( {ω}_{c} + {ω}_{q} ) {A}_{q} {e}^{j ( {ω}_{c} + {ω}_{q} ) ( t - {ψ}_{A} )} + {\sum }_{q = m + 1}^{2 m} {H}_{AB} ( {ω}_{c} + {ω}_{q} ) {A}_{q} {e}^{j ( {ω}_{c} + {ω}_{q} ) ( t - {ψ}_{A} - {τ}_{AB} )} + {\sum }_{q = 2 m + 1}^{3 m} {H}_{AB} ( {ω}_{c} + {ω}_{q} ) {A}_{q} {e}^{j ( {ω}_{c} + {ω}_{q} ) ( t - {ψ}_{A} - {τ}_{AC} )} + … = {\sum }_{q = 1}^{m} {P}_{AB} ( {ω}_{c} + {ω}_{q} ) {A}_{q} {e}^{j ( {ω}_{c} + {ω}_{q} ) ( t - {ψ}_{A} - {τ}_{AB} )} + {\sum }_{q = m + 1}^{2 m} {P}_{AB} ( {ω}_{c} + {ω}_{q} ) {A}_{q} {e}^{j ( {ω}_{c} + {ω}_{q} ) ( t - {ψ}_{A} - {τ}_{AB} )} + {\sum }_{q = 2 m + 1}^{3 m} {P}_{AB} ( {ω}_{c} + {ω}_{q} ) {A}_{q} {e}^{j ( {ω}_{c} + {ω}_{q} ) ( t - {ψ}_{A} - {τ}_{AB} )} + \qquad [ Equation 52 ]$$

Subcarrier vector [symbol] _{ab} obtained by FFT decomposition of N signal samples received by the V2X-UE B 500B is represented by Equation 53. If the initial complex coefficients A₁, A₂, . . . A₍ₖ₊₁₎ₘ assigned to subcarriers are known in advance, they can be removed.

$${𝕐}_{ab} = N \cdot [ \begin{matrix}{P}_{AB} ( {ω}_{c} + {ω}_{1} ) {e}^{j ( {ω}_{c} + {ω}_{1} ) ( {ψ}_{B} - {ψ}_{A} - {τ}_{AB} )} \\ {P}_{AB} ( {ω}_{c} + {ω}_{2} ) {e}^{j ( {ω}_{c} + {ω}_{2} ) ( {ψ}_{B} - {ψ}_{A} - {τ}_{AB} )} \\ ⋮ \\ {P}_{AB} ( {ω}_{c} + {ω}_{m} ) {e}^{j ( {ω}_{c} + {ω}_{m} ) ( {ψ}_{B} - {ψ}_{A} - {τ}_{AB} )} \\ {P}_{AB} ( {ω}_{c} + {ω}_{m + 1} ) {e}^{j ( {ω}_{c} + {ω}_{m + 1} ) ( {ψ}_{B} - {ψ}_{A} - 2 {τ}_{AB} )} \\ {P}_{AB} ( {ω}_{c} + {ω}_{m + 2} ) {e}^{j ( {ω}_{c} + {ω}_{m + 2} ) ( {ψ}_{B} - {ψ}_{A} - 2 {τ}_{AB} )} \\ ⋮ \\ {P}_{AB} ( {ω}_{c} + {ω}_{2 m} ) {e}^{j ( {ω}_{c} + {ω}_{2 m} ) ( {ψ}_{B} - {ψ}_{A} - 2 {τ}_{AB} )} \\ {P}_{AB} ( {ω}_{c} + {ω}_{2 m + 1} ) {e}^{j ( {ω}_{c} + {ω}_{2 m + 1} ) ( {ψ}_{B} - {ψ}_{A} - {τ}_{AB} - {τ}_{AC} )} \\ {P}_{AB} ( {ω}_{c} + {ω}_{2 m + 2} ) {e}^{j ( {ω}_{c} + {ω}_{2 m + 2} ) ( {ψ}_{B} - {ψ}_{A} - {τ}_{AB} - {τ}_{AC} )} \\ ⋮ \\ {P}_{AB} ( {ω}_{c} + {ω}_{3 m} ) {e}^{j ( {ω}_{c} + {ω}_{3 m} ) ( {ψ}_{B} - {ψ}_{A} - {τ}_{AB} - {τ}_{AC} )}\end{matrix} ] + {σ}_{AB} \qquad [ Equation 53 ]$$

The subcarrier vector [symbol] _{ab} is divided into (k+1) pieces of subvectors of each length m.

$$\begin{matrix}{𝕐}_{ab 1} = N \cdot [ \begin{matrix}{P}_{AB} ( {ω}_{c} + {ω}_{1} ) {e}^{j ( {ω}_{c} + {ω}_{1} ) ( {ψ}_{B} - {ψ}_{A} - {τ}_{AB} )} \\ {P}_{AB} ( {ω}_{c} + {ω}_{2} ) {e}^{j ( {ω}_{c} + {ω}_{2} ) ( {ψ}_{B} - {ψ}_{A} - {τ}_{AB} )} \\ ⋮ \\ {P}_{AB} ( {ω}_{c} + {ω}_{m} ) {e}^{j ( {ω}_{c} + {ω}_{m} ) ( {ψ}_{B} - {ψ}_{A} - {τ}_{AB} )}\end{matrix} ] + {σ}_{AB 1} \\ {𝕐}_{ab 2} = N \cdot [ \begin{matrix}{P}_{AB} ( {ω}_{c} + {ω}_{m + 1} ) {e}^{j ( {ω}_{c} + {ω}_{m + 1} ) ( {ψ}_{B} - {ψ}_{A} - 2 {τ}_{AB} )} \\ {P}_{AB} ( {ω}_{c} + {ω}_{m + 2} ) {e}^{j ( {ω}_{c} + {ω}_{m + 2} ) ( {ψ}_{B} - {ψ}_{A} - 2 {τ}_{AB} )} \\ ⋮ \\ {P}_{AB} ( {ω}_{c} + {ω}_{2 m} ) {e}^{j ( {ω}_{c} + {ω}_{2 m} ) ( {ψ}_{B} - {ψ}_{A} - 2 {τ}_{AB} )}\end{matrix} ] + {σ}_{AB 2} \\ {𝕐}_{ab 3} = N \cdot [ \begin{matrix}{P}_{AB} ( {ω}_{c} + {ω}_{2 m + 1} ) {e}^{j ( {ω}_{c} + {ω}_{2 m + 1} ) ( {ψ}_{B} - {ψ}_{A} - {τ}_{AB} - {τ}_{AC} )} \\ {P}_{AB} ( {ω}_{c} + {ω}_{2 m + 2} ) {e}^{j ( {ω}_{c} + {ω}_{2 m + 2} ) ( {ψ}_{B} - {ψ}_{A} - {τ}_{AB} - {τ}_{AC} )} \\ ⋮ \\ {P}_{AB} ( {ω}_{c} + {ω}_{3 m} ) {e}^{j ( {ω}_{c} + {ω}_{3 m} ) ( {ψ}_{B} - {ψ}_{A} - {τ}_{AB} - {τ}_{AC} )}\end{matrix} ] + {σ}_{AB 3}\end{matrix} \qquad [ Equation 54 ]$$

V2X-UE B 500B calculates the self-conjugated difference between the lower m−1 subvectors and the upper m−1 subvectors for each separated vector of Equation 54 and applies the arg (angle) sum function to the conjugated vectors. For example, self-conjugate products of the subvector [symbol] _{ab1} and the result of arg (angle) sum function is described in Equation 55.

$${𝕐}_{a b 1} {𝕐}_{a b 1}^{*} = N \cdot [ \begin{matrix}{P}_{AB} ( {ω}_{c} + {ω}_{2} ) {e}^{j ( {ω}_{c} + {ω}_{2} ) ( {ψ}_{B} - {ψ}_{A} - {τ}_{AB} )} \\ {P}_{AB} ( {ω}_{c} + {ω}_{3} ) {e}^{j ( {ω}_{c} + {ω}_{3} ) ( {ψ}_{B} - {ψ}_{A} - {τ}_{AB} )} \\ ⋮ \\ {P}_{AB} ( {ω}_{c} + {ω}_{m} ) {e}^{j ( {ω}_{c} + {ω}_{m} ) ( {ψ}_{B} - {ψ}_{A} - {τ}_{AB} )}\end{matrix} ] ⊙ N \cdot [ \begin{matrix}{P}_{AB}^{*} ( {ω}_{c} + {ω}_{1} ) {e}^{- j ( {ω}_{c} + {ω}_{1} ) ( {ψ}_{B} - {ψ}_{A} - {τ}_{AB} )} \\ {P}_{AB}^{*} ( {ω}_{c} + {ω}_{2} ) {e}^{- j ( {ω}_{c} + {ω}_{2} ) ( {ψ}_{B} - {ψ}_{A} - {τ}_{AB} )} \\ ⋮ \\ {P}_{AB}^{*} ( {ω}_{c} + {ω}_{m - 1} ) {e}^{- j ( {ω}_{c} + {ω}_{m - 1} ) ( {ψ}_{B} - {ψ}_{A} - {τ}_{AB} )}\end{matrix} ] = {N}^{2} \cdot [ \begin{matrix}{P}_{AB} ( {ω}_{c} + {ω}_{2} ) {P}_{AB}^{*} ( {ω}_{c} + {ω}_{1} ) {e}^{j ( {ω}_{2} - {ω}_{1} ) ( {ψ}_{B} - {ψ}_{A} - {τ}_{AB} )} \\ {P}_{AB} ( {ω}_{c} + {ω}_{2} ) {P}_{AB}^{*} ( {ω}_{c} + {ω}_{1} ) {e}^{j ( {ω}_{3} - {ω}_{2} ) ( {ψ}_{B} - {ψ}_{A} - {τ}_{AB} )} \\ \\ {P}_{AB} ( {ω}_{c} + {ω}_{m} ) {P}_{AB}^{*} ( {ω}_{c} + {ω}_{m - 1} ) {e}^{j ( {ω}_{m} - {ω}_{m - 1} ) ( {ψ}_{B} - {ψ}_{A} - {τ}_{AB} )}\end{matrix} ] arg ( sum ( {𝕐}_{a b 1} {𝕐}_{a b 1}^{*} ) ) ≅ arg ( {e}^{j {ω}_{g} ( {ψ}_{B} - {ψ}_{A} - {τ}_{A B} )} ) = {ω}_{g} ( {ψ}_{B} - {ψ}_{A} - {τ}_{A B} ) \qquad [ Equation 55 ]$$

Similarly, self-conjugate products and the equation of the arg (angle) sum function of subvector [symbol] _{ab2} may be described in Equation 56.

$${𝕐}_{a b 1} {𝕐}_{a b 1}^{*} = N \cdot [ \begin{matrix}{P}_{AB} ( {ω}_{c} + {ω}_{m + 2} ) {e}^{j ( {ω}_{c} + {ω}_{m + 2} ) ( {ψ}_{B} - {ψ}_{A} - 2 {τ}_{AB} )} \\ {P}_{AB} ( {ω}_{c} + {ω}_{m + 3} ) {e}^{j ( {ω}_{c} + {ω}_{m + 3} ) ( {ψ}_{B} - {ψ}_{A} - {τ}_{AB} )} \\ ⋮ \\ {P}_{AB} ( {ω}_{c} + {ω}_{2 m} ) {e}^{j ( {ω}_{c} + {ω}_{2 m} ) ( {ψ}_{B} - {ψ}_{A} - {τ}_{AB} )}\end{matrix} ] ⊙ N \cdot [ \begin{matrix}{P}_{AB}^{*} ( {ω}_{c} + {ω}_{m + 1} ) {e}^{- j ( {ω}_{c} + {ω}_{m + 1} ) ( {ψ}_{B} - {ψ}_{A} - 2 {τ}_{AB} )} \\ {P}_{AB}^{*} ( {ω}_{c} + {ω}_{m + 2} ) {e}^{- j ( {ω}_{c} + {ω}_{m + 2} ) ( {ψ}_{B} - {ψ}_{A} - {τ}_{AB} )} \\ ⋮ \\ {P}_{AB}^{*} ( {ω}_{c} + {ω}_{2 m - 1} ) {e}^{- j ( {ω}_{c} + {ω}_{2 m - 1} ) ( {ψ}_{B} - {ψ}_{A} - {τ}_{AB} )}\end{matrix} ] = {N}^{2} \cdot [ \begin{matrix}{P}_{AB} ( {ω}_{c} + {ω}_{m + 2} ) {P}_{AB}^{*} ( {ω}_{c} + {ω}_{m + 1} ) {e}^{j ( {ω}_{m + 2} - {ω}_{m + 1} ) ( {ψ}_{B} - {ψ}_{A} - 2 {τ}_{AB} )} \\ {P}_{AB} ( {ω}_{c} + {ω}_{m + 3} ) {P}_{AB}^{*} ( {ω}_{c} + {ω}_{m + 2} ) {e}^{j ( {ω}_{m + 3} - {ω}_{m + 2} ) ( {ψ}_{B} - {ψ}_{A} - 2 {τ}_{AB} )} \\ ⋮ \\ {P}_{AB} ( {ω}_{c} + {ω}_{2 m} ) {P}_{AB}^{*} ( {ω}_{c} + {ω}_{2 m - 1} ) {e}^{j ( {ω}_{2 m} - {ω}_{2 m - 1} ) ( {ψ}_{B} - {ψ}_{A} - 2 {τ}_{AB} )}\end{matrix} ] arg ( sum ( {𝕐}_{ab 2} {𝕐}_{ab 2}^{*} ) ) ≅ arg ( {e}^{j {ω}_{g} ( {ψ}_{B} - {ψ}_{A} - 2 {τ}_{A B} )} ) = {ω}_{g} ( {ψ}_{B} - {ψ}_{A} - 2 {τ}_{A B} ) \qquad [ Equation 56 ]$$

As a result. V2X-UE B 500B may extract the first path delay τ_{BA} using Equation 55 and Equation 56 by applying Equation 57.

$${τ}_{AB} = ( arg ( sum ( {𝕐}_{ab 1} {𝕐}_{ab 1}^{*} ) ) - arg ( sum ( {𝕐}_{ab 2} {𝕐}_{ab 2}^{*} ) ) ) / {ω}_{g} \qquad [ Equation 57 ]$$

Similarly, Equation 58 shows the result of self-conjugate products and the arg (angle) sum function of subvector [symbol] _{ab3}.

$${𝕐}_{ab 3} {𝕐}_{ab 3}^{*} = N \cdot [ \begin{matrix}{P}_{AB} ( {ω}_{c} + {ω}_{2 m + 2} ) {e}^{j ( {ω}_{c} + {ω}_{2 m + 2} ) ( {ψ}_{B} - {ψ}_{A} - {τ}_{AB} - {τ}_{AC} )} \\ {P}_{AB} ( {ω}_{c} + {ω}_{2 m + 3} ) {e}^{j ( {ω}_{c} + {ω}_{2 m + 3} ) ( {ψ}_{B} - {ψ}_{A} - {τ}_{AB} - {τ}_{AC} )} \\ ⋮ \\ {P}_{AB} ( {ω}_{c} + {ω}_{3 m} ) {e}^{j ( {ω}_{c} + {ω}_{3 m} ) ( {ψ}_{B} - {ψ}_{A} - {τ}_{AB} - {τ}_{AC} )}\end{matrix} ] ⊙ N \cdot [ \begin{matrix}{P}_{AB}^{*} ( {ω}_{c} + {ω}_{2 m + 1} ) {e}^{- j ( {ω}_{c} + {ω}_{2 m + 1} ) ( {ψ}_{B} - {ψ}_{A} - {τ}_{AB} - {τ}_{AC} )} \\ {P}_{AB}^{*} ( {ω}_{c} + {ω}_{2 m + 2} ) {e}^{- j ( {ω}_{c} + {ω}_{2 m + 2} ) ( {ψ}_{B} - {ψ}_{A} - {τ}_{AB} - {τ}_{AC} )} \\ ⋮ \\ {P}_{AB}^{*} ( {ω}_{c} + {ω}_{3 m - 1} ) {e}^{- j ( {ω}_{c} + {ω}_{3 m - 1} ) ( {ψ}_{B} - {ψ}_{A} - {τ}_{AB} - {τ}_{AC} )}\end{matrix} ] = {N}^{2} \cdot [ \begin{matrix}{P}_{AB} ( {ω}_{c} + {ω}_{2 m + 2} ) {P}_{AB}^{*} ( {ω}_{c} + {ω}_{2 m + 1} ) {e}^{j ( {ω}_{2 m + 2} - {ω}_{m + 1} ) ( {ψ}_{B} - {ψ}_{A} - {τ}_{AB} - {τ}_{AC} )} \\ {P}_{AB} ( {ω}_{c} + {ω}_{2 m + 3} ) {P}_{AB}^{*} ( {ω}_{c} + {ω}_{2 m + 2} ) {e}^{j ( {ω}_{m + 3} - {ω}_{m + 2} ) ( {ψ}_{B} - {ψ}_{A} - {τ}_{AB} - {τ}_{AC} )} \\ ⋮ \\ {P}_{AB} ( {ω}_{c} + {ω}_{3 m} ) {P}_{AB}^{*} ( {ω}_{c} + {ω}_{3 m - 1} ) {e}^{j ( {ω}_{3 m} - {ω}_{3 m - 1} ) ( {ψ}_{B} - {ψ}_{A} - {τ}_{AB} - {τ}_{AC} )}\end{matrix} ] arg ( sum ( {𝕐}_{ab 3} {𝕐}_{ab 3}^{*} ) ) ≅ arg ( {e}^{j {ω}_{g} ( {ψ}_{B} - {ψ}_{A} - {τ}_{AB} - {τ}_{AC} )} ) = {ω}_{g} ( {ψ}_{B} - {ψ}_{A} - {τ}_{AB} - {τ}_{AC} ) \qquad [ Equation 58 ]$$

V2X-UE B 500B may also extract the information of τ_{AC} which is the path delay between RTP Server Node or V2X-UE A 500A and neighbor Node V2X-UE C 500C by calculating difference between Equation 55 and Equation 58. This may be represented in Equation 59.

$${τ}_{A C} = ( arg ( sum ( {𝕐}_{ab 1} {𝕐}_{ab 1}^{*} ) ) - arg ( sum ( {𝕐}_{a b 3} {𝕐}_{a b 3}^{*} ) ) ) / {ω}_{g} \qquad [ Equation 59 ]$$

Therefore, V2X-UEs receiving the RTPD reference signal from RTP Server Node or V2X-UE A 500A may obtain not only the information of its own path delay but also the path delays of between the RTP server and other Nodes using Equation 53 to Equation 59.

UE-to-UE distance information between V2X-UE devices cannot be directly extracted from the RTPD reference signal. However, if the RTPU reference signal transmitted by neighboring V2X-UEs are captured and stored, the UE-to-UE path delay information may be calculated by combining the RTPU and RTPD information.

In another example, V2X-UE C 500C may transmit an RTPU_{Cpass}(t) reference signal toward RTP Server Node or V2X-UE A 500A, and this signal is also captured by V2X-UE B 500B. Equation 60 may describe the passband signal of V2X-UE C 500C.

$${RTPU}_{Cpass} ( t ) = {\sum }_{q = 1}^{m} {C}_{q} {e}^{j ( {ω}_{c} + {ω}_{q} ) ( t - {ψ}_{C} )} + {\sum }_{q = m + 1}^{2 m} {C}_{q} {e}^{j ( {ω}_{c} + {ω}_{q} ) ( t - {ψ}_{A} - {τ}_{C A} )} \qquad [ Equation 60 ]$$

The reference signal reaching V2X-UE B 500B through V2X-UE B 500B and V2X-UE C 500C channel is shown in Equation 61.

$${RTPU}_{Cc 𝒽} ( t ) = {\sum }_{q = 1}^{m} {H}_{BC} ( {ω}_{c} + {ω}_{q} ) {C}_{q} {e}^{j ( {ω}_{c} + {ω}_{q} ) ( t - {ψ}_{C} )} + {\sum }_{q = m + 1}^{2 m} {H}_{BC} ( {ω}_{c} + {ω}_{q} ) {C}_{q} {e}^{j ( {ω}_{c} + {ω}_{q} ) ( t - {ψ}_{A} - {τ}_{AC} )} = {\sum }_{q = 1}^{3 m} {P}_{BC} ( {ω}_{c} + {ω}_{q} ) {C}_{q} {e}^{j ( {ω}_{c} + {ω}_{q} ) ( t - {ψ}_{C} - {τ}_{BC} )} + {\sum }_{q = m + 1}^{2 m} {P}_{BC} ( {ω}_{c} + {ω}_{q} ) {C}_{q} {e}^{j ( {ω}_{c} + {ω}_{q} ) ( t - {ψ}_{A} - {τ}_{AC} - {τ}_{BC} )} \qquad [ Equation 61 ]$$

The down-converted baseband signal may be represented in Equation 62.

$${y}_{cb} ( t ) = {e}^{- j {ω}_{c} ( t - {ψ}_{B} )} \cdot {RTPU}_{C c 𝒽} ( t ) = {e}^{j {ω}_{c} ( {ψ}_{B} - {ψ}_{C} - {τ}_{BC} )} {\sum }_{q} {P}_{BC} ( {ω}_{c} + {ω}_{q} ) {C}_{q} {e}^{j {ω}_{q} ( t - {ψ}_{C} - {τ}_{BC} )} + {e}^{j {ω}_{c} ( {ψ}_{B} - {ψ}_{A} - {τ}_{AC} - {τ}_{BC} )} {\sum }_{q} {P}_{BC} ( {ω}_{c} + {ω}_{q} ) {C}_{q} {e}^{j {ω}_{q} ( t - {ψ}_{A} - {τ}_{AC} - {τ}_{BC} )} \qquad [ Equation 62 ]$$

The FFT decomposed subcarrier vector [symbol] _{cb} is described in Equation 63.

$${𝕐}_{c b} = N \cdot [ \begin{matrix}{P}_{BC} ( {ω}_{c} + {ω}_{1} ) {e}^{j ( {ω}_{c} + {ω}_{1} ) ( {ψ}_{B} - {ψ}_{C} - {τ}_{BC} )} \\ {P}_{BC} ( {ω}_{c} + {ω}_{2} ) {e}^{j ( {ω}_{c} + {ω}_{2} ) ( {ψ}_{B} - {ψ}_{C} - {τ}_{BC} )} \\ ⋮ \\ {P}_{BC} ( {ω}_{c} + {ω}_{m} ) {e}^{j ( {ω}_{c} + {ω}_{m} ) ( {ψ}_{B} - {ψ}_{C} - {τ}_{BC} )} \\ {P}_{BC} ( {ω}_{c} + {ω}_{m + 1} ) {e}^{j ( {ω}_{c} + {ω}_{m + 1} ) ( {ψ}_{B} - {ψ}_{A} - {τ}_{AC} - {τ}_{BC} )} \\ {P}_{BC} ( {ω}_{c} + {ω}_{m + 2} ) {e}^{j ( {ω}_{c} + {ω}_{m + 2} ) ( {ψ}_{B} - {ψ}_{A} - {τ}_{AC} - {τ}_{BC} )} \\ ⋮ \\ {P}_{BC} ( {ω}_{c} + {ω}_{2 m} ) {e}^{j ( {ω}_{c} + {ω}_{2 m} ) ( {ψ}_{B} - {ψ}_{A} - {τ}_{AC} - {τ}_{BC} )}\end{matrix} ] + {σ}_{C B} \qquad [ Equation 63 ]$$

[symbol] _{cb} vector is split into 2 upper and lower vectors, [symbol] _{cb1}, [symbol] _{cb2} respectively.

$$\begin{matrix}{𝕐}_{cb 1} = N \cdot [ \begin{matrix}{P}_{BC} ( {ω}_{c} + {ω}_{1} ) {e}^{j ( {ω}_{c} + {ω}_{1} ) ( {ψ}_{B} - {ψ}_{C} - {τ}_{BC} )} \\ {P}_{BC} ( {ω}_{c} + {ω}_{2} ) {e}^{j ( {ω}_{c} + {ω}_{2} ) ( {ψ}_{B} - {ψ}_{C} - {τ}_{BC} )} \\ ⋮ \\ {P}_{BC} ( {ω}_{c} + {ω}_{m} ) {e}^{j ( {ω}_{c} + {ω}_{m} ) ( {ψ}_{B} - {ψ}_{C} - {τ}_{BC} )}\end{matrix} ] + {σ}_{BC 1} \\ {𝕐}_{cb 2} = N \cdot [ \begin{matrix}{P}_{BC} ( {ω}_{c} + {ω}_{m + 1} ) {e}^{j ( {ω}_{c} + {ω}_{m + 1} ) ( {ψ}_{B} - {ψ}_{A} - {τ}_{AC} - {τ}_{BC} )} \\ {P}_{BC} ( {ω}_{c} + {ω}_{m + 2} ) {e}^{j ( {ω}_{c} + {ω}_{m + 2} ) ( {ψ}_{B} - {ψ}_{A} - {τ}_{AC} - {τ}_{BC} )} \\ ⋮ \\ {P}_{BC} ( {ω}_{c} + {ω}_{2 m} ) {e}^{j ( {ω}_{c} + {ω}_{2 m} ) ( {ψ}_{B} - {ψ}_{A} - {τ}_{AC} - {τ}_{BC} )}\end{matrix} ] + {σ}_{BC 2}\end{matrix} \qquad [ Equation 64 ]$$

The lower m−1 subvectors and upper m−1 subvectors of [symbol] _{cb2} in Equation 64 are differentiated by conjugate multiplication operation as represented in Equation 65.

$${𝕐}_{c b 2} {𝕐}_{c b 2}^{*} = {N}^{2} \cdot [ \begin{matrix}{P}_{BC} ( {ω}_{c} + {ω}_{m + 1} ) {P}_{BC}^{*} ( {ω}_{c} + {ω}_{m + 2} ) {e}^{j {ω}_{g} ( {ψ}_{B} - {ψ}_{A} - {τ}_{AC} - {τ}_{BC} )} \\ {P}_{BC} ( {ω}_{c} + {ω}_{m + 2} ) {P}_{BC}^{*} ( {ω}_{c} + {ω}_{m + 3} ) {e}^{j {ω}_{g} ( {ψ}_{B} - {ψ}_{A} - {τ}_{AC} - {τ}_{BC} )} \\ ⋮ \\ {P}_{BC} ( {ω}_{c} + {ω}_{2 m + 1} ) {P}_{BC}^{*} ( {ω}_{c} + {ω}_{2 m} ) {e}^{j {ω}_{g} ( {ψ}_{B} - {ψ}_{A} - {τ}_{AC} - {τ}_{BC} )}\end{matrix} ] \qquad [ Equation 65 ]$$

A phase difference subcarrier gap frequency ω_{g} is obtained by applying the arg (angle) function in Equation 65.

$$arg ( sum ( {cb 2}_{} {cb 2}_{*}^{} ) ) ≅ {ω}_{g} ( {ψ}_{B} - {ψ}_{A} - {τ}_{AC} - {τ}_{BC} ) \\ ∴ {ψ}_{B} - {ψ}_{A} - {τ}_{AC} - {τ}_{BC} = arg ( sum ( {cb 2}_{} {cb 2}_{*}^{} ) ) / {ω}_{g} \qquad [ Equation 66 ]$$

From Equation 66, τ_{BC} is described as represented in Equation 67.

$${τ}_{BC} = {ψ}_{B} - {ψ}_{A} - {τ}_{AC} - arg ( sum ( {cb 2}_{} {cb 2}_{*}^{} ) ) / {ω}_{g} \qquad [ Equation 67 ]$$

Note that V2X-UE B 500B already knows the information of (ψ_{B}−ψ_{A}−τ_{AC}) as the Node received RTPD signal using Equation 58. This is represented in Equation 68.

$${ψ}_{B} - {ψ}_{A} - {τ}_{AC} = ( {τ}_{AB} + arg ( sum ( {ab 3}_{} {ab 3}_{*}^{} ) ) ) / {ω}_{g} \qquad [ Equation 68 ]$$

Therefore, we may resolve the information of path delay τ_{BC} by substituting Equation 68 in Equation 67.

$${τ}_{BC} = ( {τ}_{AB} + arg ( sum ( {ab 3}_{} {ab 3}_{*}^{} ) ) - arg ( sum ( {cb 2}_{} {cb 2}_{*}^{} ) ) ) / {ω}_{g} \qquad [ Equation 69 ]$$

Recall that τ_{BA} in Equation 69 can be obtained from Equation 57. As a result, UE-to-UE distance information between V2X-UEs communicating with the RTP server Node can be known by applying the equations. In order to provide full-mesh UE-to-UE distance information by using naïve three-way RTT method, a total of (n)² message exchange may be required. However, when applying the RTP server method as disclosed, all V2X-UEs may obtain entire UE-to-UE distance information only by (2n) number of message exchanges. The reduction of the number of message exchanges may significantly improve bandwidth usage and latency. Therefore, the above-mentioned RTP method can provide an accurate carrier-based phase measurement result as well as reducing the overhead configuration for message exchange.

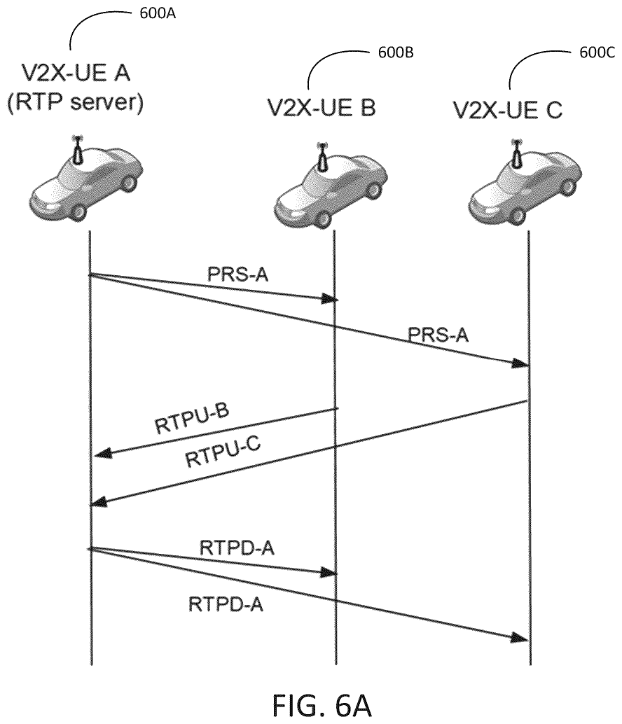

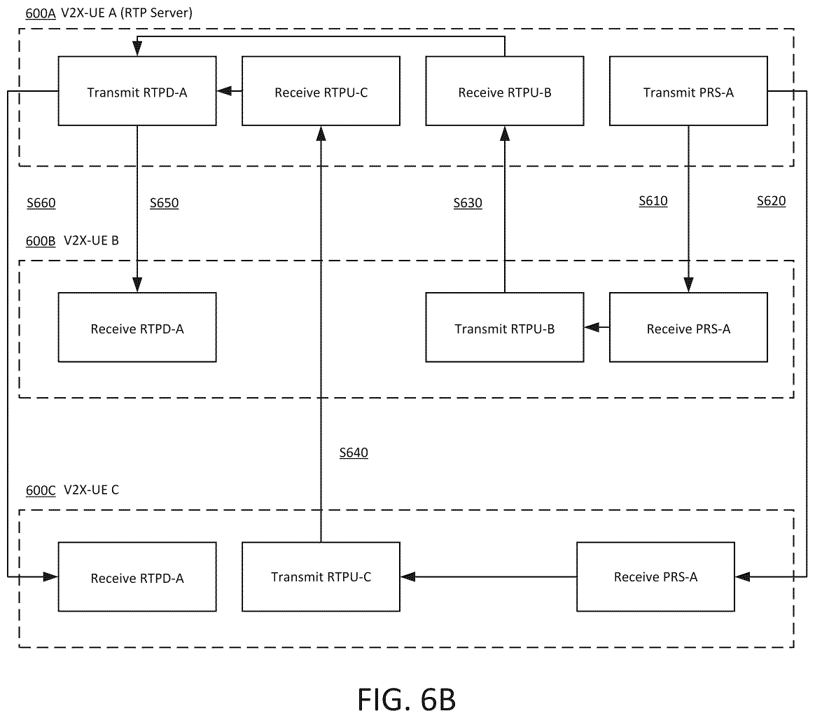

FIG. 6A is a conceptual diagram showing the configuration of a communication node constituting a communication system by way of example. In some embodiments, one or more moving vehicles may transmit and receive positioning information from each other. For example, a first vehicle, V2X-UE A 600A may transmit reference signals, to a second vehicle, V2X-UE B 600B, and a third vehicle, V2X-UE C 600C, requesting location information. Upon receiving the reference signals from the V2X-UE A 600A, the V2X-UE B 600B, and V2X-UE C 600C may transmit their respective information via their own reference signals. Once the V2X-UE A 600A receives the respective information, the V2X-UE A 600A may then inform the positioning of all vehicles to both the V2X-UE B 600B and V2X-UE C 600C. Thus, all three moving vehicles may be informed of the positioning, location, and timing of other vehicles based on the reference signals.

FIG. 6B is a block diagram showing the configuration of a communication node constituting a communication system by way of example. In some embodiments, a V2X-UE A 600A may be selected as a RTP server, capable of transmitting a request signal for information related to positioning, location, and/or timing of other moving vehicles in its vicinity. For example, in steps S610 and S620, a V2X-UE A 600A may transmit a positioning reference signal denoted as PRS-A to a second V2X-UE B 600B and a third V2X-UE C 600C, respectively. Upon receiving the request for information, in steps S630 and S640, V2X-UE B 600B and V2X-UE C 600C may transmit their positional information via a RTPU-B signal and RTPU-C signal respectively.

Upon receiving the RTPU-B and RTPU-C signals, V2X-UE A 600A now has positional information regarding V2X-UE B 600B and V2X-UE C 600C. At the same time, V2X-UE B 600B and V2X-UE C 600C do not have information regarding any other V2X-UE. Thus, in steps S650 and S660, V2X-UE A 600A may transmit RTPD-As based on the received signals to inform V2X-UE B 600B and V2X-UE C 600C about the positions of other V2X-UEs.

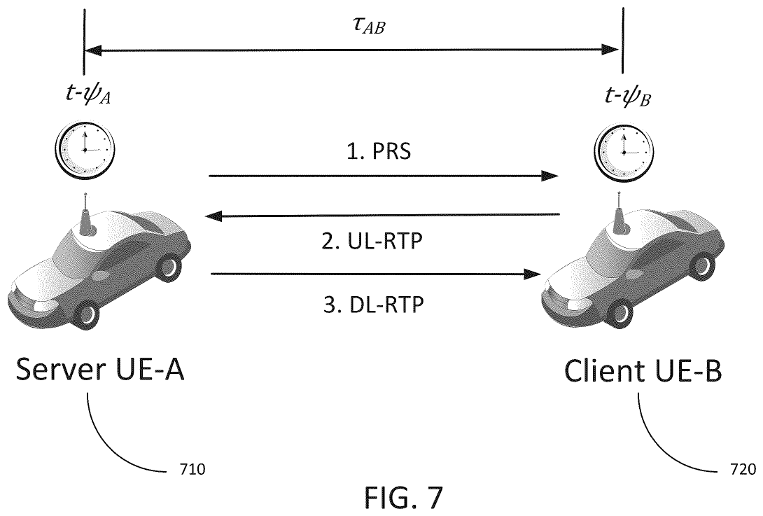

FIG. 7 is a conceptual diagram illustrating a single and double sided RTP method according to an exemplary embodiment. In some embodiments, internal clock signals of Server UE-A 710 and Client UE-B 720 are generated by unsynchronized local oscillators, which results in their local times being represented as t−ψ_{A} and t−ψ_{B} respectively. While the local clock errors ψ_{A} and ψ_{B} can be changed slightly over time, this example assumes that the instantaneous time errors are fixed constants.

The RTP procedure begins with Server UE-A 710 periodically broadcasting the PRS signal generated by Equation 7A, where the PRS signal is the same reference signal used in methods such as time difference of arrival (TDoA) or angle of arrival (AoA).

$${PRS}_{A} ( t ) = {A}_{1} {e}^{j {ω}_{1} ( t - {ψ}_{A} )} + {A}_{2} {e}^{j {ω}_{2} ( t - {ψ}_{A} )} + … + {A}_{m} {e}^{j {ω}_{m} ( t - {ψ}_{A} )} = {\sum }_{q = 1}^{m} {A}_{q} {e}^{j {ω}_{q} ( t - {ψ}_{A} )} \qquad [ Equation 7 A ]$$

In Equation 7A, ω₁, ω₂, ωₘ represents the angular frequencies of subcarriers that are equally spaced in the frequency domain. The legacy comb-N structure can also be viewed as a form of equal spacing of subcarriers. A₁, A₂, . . . Aₘ represent the initial phase sequence of each subcarrier that makes up the PRS signal. This initial phase sequence can be applied for purposes such as avoiding Peak-to-Average Power Ratio (PAPR) and can be removed if the receiver knows this sequence.

The PRS signal of a transmitter can be transmitted periodically at k times of a slot interval. If the initial phase sequences A₁, A₂, . . . Aₘ for each iteration cycle remains unchanged, we can see that the same PRS waveform repeats every k times the slot length L, as shown in Equation 7B.

$${PRS}_{A} ( t ) = {PRS}_{A} ( t + kL ) , L = slot length \qquad [ Equation 7 B ]$$

L denotes the length of a slot, and k is the PRS iteration cycle. The implication is that the phase value of the PRS signal measured at time t+kL for any k value is equal to the phase value measured at time, t. In other words, when applying the phase-based measurement method, which operates on a slot basis, all signals measured at different slot times can be considered to be measured at the same time, t, hence the phase comparison can be made regardless of the slot location. Therefore, relative time can be measured in a more flexible and simple way than the RTT method.

The baseband PRS signal in Equation 7B is mixed with the carrier signal of frequency ω_{c} at the RF front end of the transmitter and modulated into the passband signal in Equation 7C.

$${PRS}_{Apass} ( t ) = {e}^{j {ω}_{c} ( t - {ψ}_{A} )} \cdot {PRS}_{A} ( t ) = {\sum }_{q = 1}^{m} {A}_{q} {e}^{j ( {ω}_{c} + {ω}_{q} ) ( t - {ψ}_{A} )} \qquad [ Equation 7 C ]$$

The passband signal in Equation 7C above reaches Client UE-B 720 after τ_{AB} delay. This can be represented by Equation 7D below. To simplify the description, Equation 7D does not include a multipath channel expression, but just shows a single transmission delay on a line-of-sight path.

$${PRS}_{Ach} ( t ) = {e}^{- j ( {ω}_{c} + {ω}_{q} ) {τ}_{AB}} \cdot {PRS}_{Apass} ( t ) = {\sum }_{q = 1}^{m} {A}_{q} {e}^{j ( {ω}_{c} + {ω}_{q} ) ( t - {ψ}_{A} - {τ}_{AB} )} \qquad [ Equation 7 D ]$$

At Client UE-B 720, the received passband PRS signal is mixed with a carrier signal of reverse complex exponents to perform down conversion, as shown in Equation 7E. This process takes into account the local clock error WB of Client UE-B 720.

$${y}_{B} ( t ) = {e}^{- j {ω}_{c} ( t - {ψ}_{B} )} \cdot {PRS}_{Ach} ( t ) = {\sum }_{q} {A}_{q} {e}^{j ( {ω}_{c} ( {ψ}_{B} - {ψ}_{A} - {τ}_{AB} ) + {ω}_{q} ( t - {ψ}_{A} - {τ}_{AB} ) )} \qquad [ Equation 7 E ]$$

Client UE-B 720 collects the down converted baseband signal samples of Equation 7E above and decomposes them using the FFT process. Hence the PRS subcarriers of ω₁, ω₂, ωₘ is recovered. The recovered PRS subcarriers are shown in the vector form of Equation 7F.

$${B}_{} = N \cdot [ \begin{matrix}{A}_{1} {e}^{j ( {ω}_{c} + {ω}_{1} ) ( {ψ}_{B} - {ψ}_{A} - {τ}_{AB} )} \\ {A}_{2} {e}^{j ( {ω}_{c} + {ω}_{2} ) ( {ψ}_{B} - {ψ}_{A} - {τ}_{AB} )} \\ ⋮ \\ {A}_{m} {e}^{j ( {ω}_{c} + {ω}_{m} ) ( {ψ}_{B} - {ψ}_{A} - {τ}_{AB} )}\end{matrix} ] + {σ}_{B} \qquad [ Equation 7 F ]$$

The subcarrier vector [symbol] _{B} in Equation 7F above contains both local clock error ψ_{B}−ψ_{A} and path delay τ_{AB} in the exponent part of the complex number. σ_{B} represents the residual error that remains after the FFT computation.

Note that the subcarrier vector [symbol] _{B} includes the initial phase sequence A₁, A₂, . . . Aₘ of the PRS signal sent by Server UE-A 710. It can be removed if the Client UE-B 720 knows the sequence. Equation 7G shows the calculated carrier phase value, obtained by removing the initial phase sequence value of A and then summing each complex value of the [symbol] _{B} vector elements, and applying the arc-tangent function (i.e., angle function).

arg(sum( [symbol] _{B})≅arg(e^{j(ω}^{_{c}}^{+ω}^{_{Δ}}^{)(ψ}^{_{B}}^{-ψ}^{_{A}}^{-τ}^{_{AB}}⁾)=(ω_{c}+ω_{Δ})(ψ_{B}−ψ_{A}−τ_{AB})−2π

[symbol]

$${ε}_{AB} = {ψ}_{B} - {ψ}_{A} - {τ}_{AB} = \frac{arg ( sum ( {B}_{} ) ) + 2 π}{{ω}_{c} + {ω}_{Δ}} \qquad [ Equation 7 G ]$$

In Equation 7G, ω_{c} is the carrier frequency and ω_{Δ} is the center of the subcarrier array (ω₁ , ω₂ . . . ωₘ·ω_{c}+ω_{Δ} is a very large number (>10⁸), but the arg function returns only values between −π to +π. In order to fully recover the lost carrier phase value, it may be necessary to estimate and compensate for the hidden integer number [symbol] . This can be calculated by applying the self-conjugate calculation to the subcarrier vector [symbol] _{B} in Equation 7F. The estimated integer number [symbol] can be applied to calculate the accurate ε_{AB} value of Equation 7G.

Client UE-B 720 applies Equation 7G to inform Server UE-A 710 of the measured ε_{AB} value using a single-sided RTP message. New reference signal, UL_RTP_{B}, used for returning the phase value ε_{AB} can be configured as shown in Equation 7H.

$${UL\_RTP}_{B} ( t ) = {e}^{j {ω}_{c} {ε}_{AB}} \cdot {\sum }_{q = 1}^{m} {B}_{q} {e}^{j {ω}_{q} ( t - {ψ}_{B} + {ε}_{AB} )} \qquad [ Equation 7 H ]$$

The UL_RTP_{B} signal in Equation 7H is in fact a phase-rotated PRS_{B} signal by the amount ε_{AB} value. This gives the effect of copying the phase of the received PRS_{A} signal and returning it to Server UE-A 710.

The UL_RTP_{B} signal in Equation 7H reaches Server UE-A 710 through a carrier modulation process as described in Equations 7C through 7E. Therefore, the baseband signal that reaches Server UE-A 710 after the t+kL slot time and is down converted as shown in Equation 7I.

$${y}_{A} ( t + kL ) = {y}_{A} ( t ) = {\sum }_{q = 1}^{m} {B}_{q} {e}^{j ( - 2 {τ}_{AB} {ω}_{c} + {ω}_{q} ( t - {ψ}_{A} - 2 {τ}_{AB} ) )} \qquad [ Equation 7 I ]$$

The subcarrier vector y_{A} in Equation 7J is obtained by collecting the demodulated baseband signal samples of Equation 7H, and applying the FFT, and extracting m subcarrier elements in the frequency domain. Similar to the case of the PRS reference signal, if the Server UE-A 710 knows the initial phase sequence B₁, B₂, . . . Bₘ of the UL_RTP_{B} signal, it can be removed.

$${𝕐}_{A} = N \cdot [ \begin{matrix}{B}_{1} {e}^{- j ( {ω}_{c} + {ω}_{1} ) 2 {τ}_{AB}} \\ {B}_{2} {e}^{- j ( {ω}_{c} + {ω}_{2} ) 2 {τ}_{AB}} \\ ⋮ \\ {B}_{m} {e}^{- j ( {ω}_{c} + {ω}_{m} ) 2 {τ}_{AB}}\end{matrix} ] + {σ}_{A} \qquad [ Equation 7 J ]$$

After removing the initial phase sequence value in the vector [symbol] _{A}, the carrier phase value is calculated by summing the complex value of each element and applying the arc-tangent function (i.e., angle function) as shown in Equation 7K.

$$arg ( sum ( {A}_{} ) ) ≅ arg ( {e}^{- j ( {ω}_{c} + {ω}_{Δ} ) 2 {τ}_{AB}} ) = - ( {ω}_{c} + {ω}_{Δ} ) 2 {τ}_{AB} - 2 π \\ ∴ {τ}_{AB} = - \frac{arg ( sum ( {A}_{} ) ) + 2 π}{2 ( {ω}_{c} + {ω}_{Δ} )} \qquad [ Equation 7 K ]$$

Similar to the case of Equation 7G, Equation 7K also contains an unknown integer number [symbol] . The Server UE-A 710 can calculate the path delay τ_{AB} with high accuracy. Server UE-A 710 may further implement a double-sided RTP procedure by encoding the calculated time delay information τ_{AB} into a DL-RTPA signal similar to Equation 7H and delivering it to Client UE-B 720.

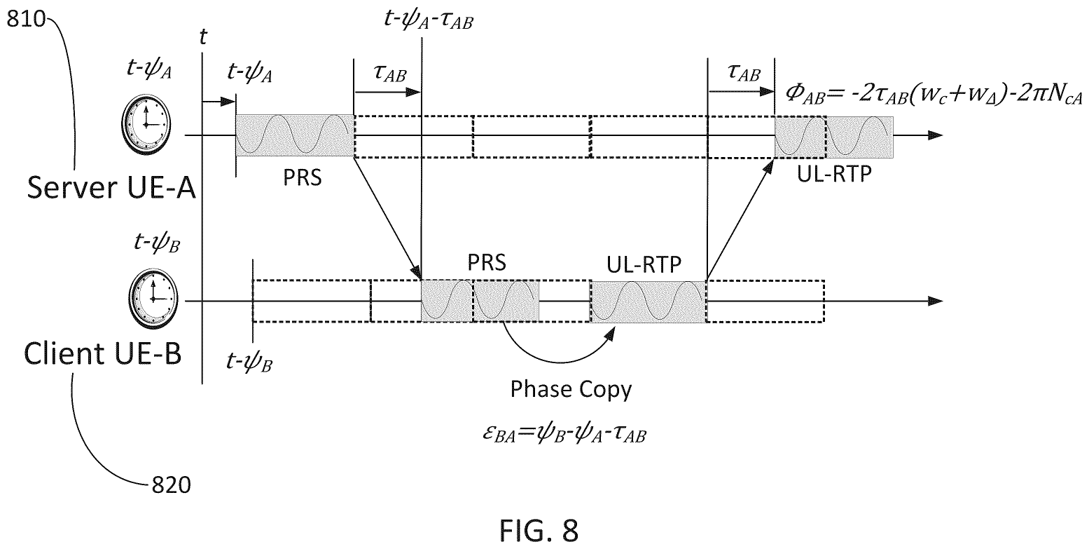

FIG. 8 is a conceptual timing diagram illustrating a single sided RTP method according to an exemplary embodiment. In some embodiments, a PRS_{A} signal transmitted by Server UE-A 810 reaches Client UE-B 820 after τ_{AB} time delay. Client UE-B 820 calculates the phase information EAB of the PRS_{A} signal through the above Equations 7E to 7G and uses it to configure the UL_RTP_{B} reference signal. The UL-RTP B signal is delivered to Server UE-A 810. By applying Equations 7I through 7K, Server UE-A 810 can finally obtain a time delay τ_{AB} that eliminates the local clock error.

One of ordinary skill in the art may easily understand that the methods and/or processes and operations described herein may be implemented using hardware components, software components, and/or a combination thereof based on description related to the example embodiments. For example, the hardware components may include a general-purpose computer and/or exclusive computing device or a specific computing device or a special feature or component of the specific computing device. The processes may be implemented using one or more processors having an internal and/or external memory, for example, a microprocessor, a controller such as a microcontroller and an embedded microcontroller, a microcomputer, an arithmetic logic unit (ALU), and a digital signal processor such as a programmable digital signal processor or other programmable devices. In addition, or, as an alternative, the processes may be implemented using an application specific integrated circuit (ASIC), a programmable gate array, such as, for example, a field programmable gate array (FPGA), a programmable logic unit (PLU), or a programmable array logic (PAL), and other devices capable of executing and responding to instructions in a defined manner, other devices configured to process electronic devices, and combinations thereof. The processing device may run an operating system (OS) and one or more software applications that run on the OS. Also, the processing device may access, store, manipulate, and create data in response to execution of the software. For purpose of simplicity, the description of a processing device is used as a singular; however, one skilled in the art will appreciate that a processing device may include a plurality of processing elements and/or multiple types of processing elements. For example, the processing device may include a plurality of processor or a single processor and a single controller. In addition, different processing configurations are possible such as parallel processors.

The software may include a computer program, a piece of code, an instruction, or some combination thereof, for independently or collectively instructing or configuring the processing device to operate as desired. Software and/or data may be embodied permanently or temporarily in any type of machine, component, physical equipment, virtual equipment, computer storage medium or device, or in a propagated signal wave capable of providing instructions or data to or being interpreted by the processing device. The software also may be distributed over network coupled computer systems so that the software is stored and executed in a distributed fashion. In particular, the software and data may be stored by one or more computer readable storage mediums.

The methods according to the example embodiments may be recorded in non-transitory computer-readable recording media including program instructions to implement various operations embodied by a computer. The media may also include, alone or in combination with the program instructions, data files, data structures, and the like. The media and program instructions may be those specially designed and constructed for the purposes, or they may be of the kind well-known and available to those having skill in the computer software arts. Examples of non-transitory computer readable recording media include magnetic media such as hard disks, floppy disks, and magnetic tape; optical media such as CD ROM, DVD, and blue-rays; magneto-optical media such as floptical disks; and hardware devices that are specially to store and perform program instructions, such as read-only memory (ROM), random access memory (RAM), flash memory, and the like. Examples of program instructions include both machine code, such as produced by a compiler and files containing structural programming languages such as C++ object-oriented programming language and high or low programming languages (assembly languages, hardware technical languages, database programming languages and techniques) to run on one of the aforementioned devices and a processor, a processor architecture, or a heterogeneous combination of combinations of different hardware and software components, or a machine capable of executing program instructions. Accordingly, they may include a machine language code, a byte code, and a high language code executable using an interpreter and the like.

Therefore, according to an aspect of at least one example embodiment, the aforementioned methods and combinations thereof may be implemented by one or more computing devices as an executable code that performs the respective operations. According to another aspect, the methods may be implemented by systems that perform the operations and may be distributed over a plurality of devices in various manners or all of the functions may be integrated into a single exclusive, stand-alone device, or different hardware. According to another aspect, devices that perform operations associated with the aforementioned processes may include the aforementioned hardware and/or software. According to another aspect, all of the sequences and combinations associated with the processes are to be included in the scope of the present disclosure.

For example, the described hardware devices may be to act as one or more software modules in order to perform the operations of the above-described example embodiments, or vice versa. The hardware devices may include a processor, such as, for example, an MPU, a CPU, a GPU, a TPU, etc., configured to be combined with a memory such as ROM/RAM configured to store program instructions and to execute the instructions stored in the memory, and may include a communicator capable of transmitting and receiving a signal with an external device. In addition, the hardware devices may include a keyboard, a mouse, and an external input device for receiving instructions created by developers.

The foregoing description has been provided for purposes of illustration and description. It is not intended to be exhaustive or to limit the disclosure. Individual elements or features of a particular example embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

Accordingly, the present disclosure is not limited to the aforementioned example embodiments and may belong to the scope of example embodiments disclosed herein and equally or equivalently modified from the claims. For examples, although the methods may be implemented in different sequence and/or components of systems, structures, apparatuses, circuits, etc., may be combined or integrated in different form or may be replaced with other components or equivalents, appropriate results may be achieved.

Such equally or equivalently modified example embodiments may include logically equivalent methods capable of achieving the same results according to the example embodiments. Accordingly, the present disclosure and the scope thereof are not limited to the aforementioned example embodiments and should be understood as a widest meaning allowable by law.

What is claimed is:

1. A positioning method performed by a node device, the positioning method comprising:
receiving, by a first node device, a positioning reference signal transmitted from a second node device, wherein the positioning reference signal comprises a time error and a propagation delay;
determining, by the first node device, a synch-vector based on the time error and the propagation delay, wherein the synch-vector is configured to remove at least one of the time error or the propagation delay from the positioning reference signal; and
applying, by the first node device, the synch-vector to the positioning reference signal to generate a synchronized positioning reference signal, wherein the synchronized positioning reference signal comprises the positioning reference signal corrected for the time error or the propagation delay.

2. The positioning method of claim 1, wherein the second node device determines a position of the first node device based on the synchronized positioning reference signal transmitted by the first node device.

3. The positioning method of claim 1, wherein the positioning reference signal comprises a plurality of subcarriers, the method further comprising determining phase difference information based on frequencies of the plurality of subcarriers, and wherein the phase difference information comprises a phase vector based on a wavelength or a frequency of at least one subcarrier among the plurality of subcarriers.

4. The positioning method of claim 3, wherein determining the synch-vector is further based on the phase difference information, wherein the phase difference information further comprises a carrier phase difference information or a subcarrier phase difference information.

5. The positioning method of claim 4, further comprising:
converting the phase difference information into a phase difference value by applying an argument angle function by:
determining a carrier phase difference value by applying a first argument angle function to the phase vector; and
determining a subcarrier phase difference value by applying a second argument angle function to a conjugate multiplication of the phase vector.

6. The positioning method of claim 1, wherein at least one of the first node device or the second node device comprises a vehicle.

7. The positioning method of claim 1, further comprising:
receiving, by a third node device, a second positioning reference signal transmitted from the second node device; and
selecting one of the first node device, the second node device, or the third node device to be a server node and others of the first node device, the second node device, or the third node device to be client nodes.

8. The positioning method of claim 1, further comprising:
receiving, by a third node device, a second positioning reference signal transmitted from the second node device; and
selecting the second node device to be a server node and the first node device and the third node device to be client nodes.

9. The positioning method of claim 8, wherein:
each of the client nodes determine a client-specific synch-vector configured to remove client-specific time error and client-specific propagation delay from the positioning reference signal received by the client node;
each of the client nodes applies the client-specific synch-vector to the positioning reference signal to generate a client-specific synchronized positioning reference signal, wherein the client-specific synchronized positioning reference signal comprises the client-specific positioning reference signal corrected for the client-specific time error and the client-specific propagation delay; and
each of the client nodes transmits the client-specific synchronized positioning reference signal to the server node, wherein the server node determines a client-specific position for each of the client nodes based on the client-specific synchronized positioning reference signals.

10. A positioning method performed by a node device, the positioning method comprising:
receiving, by a first node device, a positioning reference signal transmitted from a second node device; and
determining an unknown integer number of carrier wavelengths based on a phase difference value of a synchronized positioning reference signal, a time error, and a propagation delay.

11. The positioning method of claim 10, wherein the synchronized positioning reference signal is generated by:
receiving, by the first node device, a positioning reference signal transmitted from a second node device, wherein the positioning reference signal comprises a time error and a propagation delay;
determining, by the first node device, a synch-vector based on the time error and the propagation delay, wherein the synch-vector is configured to remove at least one of the time error or the propagation delay from the positioning reference signal; and
applying, by the first node device, the synch-vector to the positioning reference signal to generate the synchronized positioning reference signal, wherein the synchronized positioning reference signal comprises the positioning reference signal corrected for the time error or the propagation delay.

12. The positioning method of claim 10, further comprising:
determining, by the second node device, a position of the first node device based on the unknown integer number of carrier wavelengths; and
determining, by the second node device, a position of the second node device based on the unknown integer number of carrier wavelengths.

13. The positioning method of claim 10, further comprising:
receiving, by a third node device, a second positioning reference signal transmitted from the second node device; and
selecting the second node device to be a server node and the first node device and the third node device to be client nodes.

14. The positioning method of claim 13, wherein the client nodes transmit synchronized positioning reference signals based on the positioning reference signal from the server node.

15. The positioning method of claim 13, wherein:
each of the client nodes determine a client-specific synch-vector configured to remove client-specific time error and client-specific propagation delay from the positioning reference signal received by the client node;
each of the client nodes applies the client-specific synch-vector to the positioning reference signal to generate a client-specific synchronized positioning reference signal, wherein the client-specific synchronized positioning reference signal comprises the client-specific positioning reference signal corrected for the client-specific time error and the client-specific propagation delay; and
each of the client nodes transmits the client-specific synchronized positioning reference signal to the server node, wherein the server node determines a client-specific position for each of the client nodes based on the client-specific synchronized positioning reference signals.

16. The positioning method of claim 15, further comprising:
determining a first synch-vector for the first client node; and
determining a second synch-vector of the second client node.

17. The positioning method of claim 15, wherein the client-specific synchronized positioning reference signal includes 2m subcarriers and time variables of first to mth subcarriers depend on a local time of each of the client nodes, wherein the time variables of first to mth subcarriers do not depend on a local time of the server node.

18. The positioning method of claim 15, wherein each of the client nodes and the server node determine full-mesh UE-to-UE distance information based on a RTP server method in order of 2n message exchanges.

19. The positioning method of claim 13, further comprising:
generating, by the server node, a synch-vector based on propagation delay between the server node and each of the client nodes;
calculating, by the server node, a propagation delay broadcast signal sequence using the synch-vector and a signal generation vector for generating a propagation delay broadcast signal; and
transmitting, by the server node, the propagation delay broadcast signal using the propagation delay broadcast signal sequence.

20. The positioning method of claim 19, further comprising:
setting first to mth components of a synch-vector based on propagation delay between the server node and each of the client nodes to a same constant; and
setting km+1th to (k+1)mth components of the synch-vector based on propagation delay to complex numbers having a phase depending on a path delay time between a kth node and a first node.
